(19) United States
(12) Patent Application Publication
(10) Pub. No.: US 2014/0137121 A1
(43) Pub. Date: May 15, 2014

(54) JOB MANAGEMENT SYSTEM AND JOB CONTROL METHOD

(71) Applicant: HITACHI, LTD., Tokyo (JP)

(72) Inventors: Keita Asakura, Chigasaki-shi (JP); Nobuyuki Hayashi, Hadano-shi (JP)

(73) Assignee: HITACHI, LTD., Tokyo (JP)

(21) Appl. No.: 13/641,802

(22) PCT Filed: Oct. 5, 2012
(86) PCT No.: PCT/JP2012/006418

§ 371 Date: Nov. 12, 2012

(51) Int. Cl. G06F 9/48

(52) U.S. Cl. CPC G06F 9/4881
USPC 718/102

(57) ABSTRACT

In the prior art, the number of jobs that can be executed in parallel in a parallel computer is restricted by the types of licenses capable of being used or the number of licenses, and if there is insufficiency in licenses, a new job cannot be executed until already entered jobs in execution are completed. In order to solve the problems of the prior art, the present invention is designed to release a resource of a job having a low priority when license is insufficient when a job is entered, and the released resource is allocated to a job having a high priority so as to enable the job having a high priority to be executed, according to which the efficiency of use of resources is enhanced.

### TECHNICAL FIELD

The present invention relates to a job management system and a job control method.

### BACKGROUND ART

Recently, along with the rapid increase of data quantity to be processed by computers, computer systems having parallel processing functions are adopted to increase the processing speed. One example of the art of such parallel processing of multiple jobs is taught in patent literature 1.

The number of jobs capable of being executed in parallel is restricted according to the license type of the software necessary for executing jobs and the number of licenses of the license type. Therefore, it was possible according to the prior art to enter jobs considering the number of licenses and the priority level.

### CITATION LIST

### Patent Literature

PTL 1: Publication of Japanese Patent No. 3215264

### SUMMARY OF INVENTION

### Technical Problem

However, according to the prior art, when the types of licenses or the number of licenses capable of being used is insufficient, a new job could not be executed until the already-entered job being executed is completed.

Therefore, even if the execution on-going jobs are occupied by jobs having low priorities, it was not possible to execute a job having a high emergency level (urgency). However, the efficiency of use of licenses will be deteriorated if a license is not used and kept vacant for jobs having high emergency level. Such problems apply not only to software licenses but to physical hardware resources of computers.

### Solution to Problem

In order to solve the above-mentioned problems according to the present invention, when licenses are insufficient when a job is entered, a resource of a job having a low emergency level is released and the released resource is allocated to a job having a high emergency level, so as to enable execution of the job having a high emergency level.

### Advantageous Effects of Invention

According to the present invention, a job having a low emergency level can be released to enable entry of a job having a high emergency level for execution, according to which the efficiency of use of resources can be enhanced. Problems, configuration and effects other than those illustrated above can be made clear from the following detailed description of embodiments.

### BRIEF DESCRIPTION OF DRAWINGS

FIG. 1 is a view illustrating the outline of the present invention and problems according to the prior art.

FIG. 2 is an overall configuration diagram of a computer system according to the present invention.

FIG. 3 is a configuration view of an execution computer of a computer system.

FIG. 4 is a configuration view of a job management system of the computer system.

FIG. 5 is a view showing a configuration example of an execution command

FIG. 6 is a view showing a resource release queue correlation definition information.

FIG. 7 is a view showing a queue setup information.

FIG. 8 is a view showing a resource management information.

FIG. 9 is a view showing a simulation environment information.

FIG. 10 is a view showing a simulation test information.

FIG. 11 is a view showing an execution job information.

FIG. 12 is a view showing a resource information.

FIG. 13 is a view showing a license information.

FIG. 14 is a view showing a resource insufficiency occurrence history.

FIG. 15 is a view showing a resource release history.

FIG. 16 is a view showing a resource release request job list.

FIG. 17 is a view showing a release target queue list.

FIG. 18 is a view showing a release target job list.

FIG. 19 is a view showing a first job replacement operation when an immediate job is entered.

FIG. 20A is a view showing a first job replacement operation when an immediate job is entered.

FIG. 20B is a view showing a detailed action 1 of first job replacement when an immediate job is entered.

FIG. 20C is a view showing a detailed action 2 of first job replacement when an immediate job is entered.

FIG. 20D is a view showing a detailed action 3 of first job replacement when an immediate job is entered.

FIG. 21 is a view showing a second job replacement operation when an immediate job is entered.

FIG. 22 is a view showing a third job replacement operation when an immediate job is entered.

FIG. 23 is a view showing a fourth job replacement operation when an immediate job is entered.

FIG. 24 is a view showing a fifth job replacement operation when an immediate job is entered.

FIG. 25 is a view showing a sixth job replacement operation when an immediate job is entered.

FIG. 26 is a view showing a seventh job replacement processing when an immediate job is entered.

FIG. 27A is a flowchart showing a resource release—allocation job control processing.

FIG. 27B is a flowchart showing a resource release—allocation job control processing.

FIG. 27C is a flowchart showing a resource release—allocation job control processing.

FIG. 28 is a flowchart illustrating a resource release—allocation processing.

FIG. 29 is a flowchart illustrating a process for controlling interruption/stop of resource release job.

FIG. 30A is a flowchart illustrating a process for controlling a resource insufficiency monitor notice.

FIG. 30B is a flowchart showing a process for controlling a resource insufficiency monitor notice.

FIG. 31 is a view showing a configuration example of a management screen.

### DESCRIPTION OF EMBODIMENTS

Now, the preferred embodiments of the present invention will be described with reference to the drawings. In the following description, various information are referred to as “management table” and the like, but the various information can also be expressed by data structures other than tables. Further, the “management table” can also be referred to as “management information” to show that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer program can be installed to each computer from a program source. The program source can be provided via a program distribution server or storage media, for example.

Each element, such as each controller, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical range of the present invention. The number of the components can be one or more than one unless defined otherwise.

<<Outline of the Invention>>

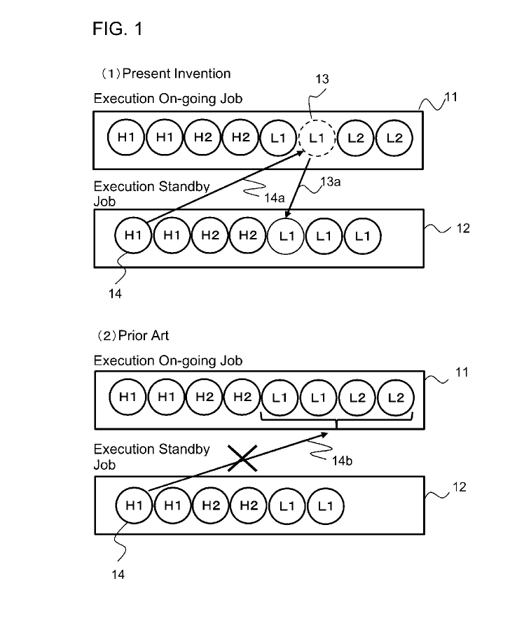

FIG. 1 is a view illustrating the outline of the present invention and the problems according to the prior art. FIG. 1 illustrates the problems according to the prior art and the outline of the present invention for solving the problems.

FIG. 1(2) illustrates a prior art job control. Reference number 11 denotes an execution on-going job queue. Reference number 12 denotes an execution standby job queue. The circles having an alphabet and a number written therein represent jobs. The alphabet represents the emergency level, wherein “H” represents the highest emergency level, and “M” and “L” represent lower emergency level in the named order. The numbers represent other queues having the same emergency level.

In the prior art, it was possible to enter jobs considering the number of licenses and priority, but the number of jobs that can be executed in parallel was restricted by the number of licenses, and when there were insufficient licenses, it was not possible to enter a new job to the execution on-going job queue 11 until the already-entered job was ended.

In other words, since according to the execution on-going queue 11 there are eight on-going jobs having reached the upper limit of the number of licenses, so that it was impossible to execute a new job. Therefore, it was not possible according to the prior art to replace an “H1” job 14 having a high emergency level stored in the execution standby job queue 12 in an execution standby state with an execution on-going job, as shown by reference number 14b.

Further, leaving a license vacant for a job having a high emergency level deteriorates the use efficiency of the license. Especially in large-scale LSI development used in large-scale computers and storage systems, many verification jobs had to be performed for a long period of time, so that efficient job control was required.

Therefore, according to the present invention, as shown in FIG. 1(1), the execution of an execution on-going “L1” job 13 is either interrupted or stopped, and as shown in reference number 13a, the job is moved from the execution on-going job queue 11 to the execution standby job queue 12. Then, the license resource (execution resource) used by “L1” job 13 is enable to be used by a “H1” job 14 having a high emergency level. Then, the “H1” job 14 is moved as shown by reference number 14a from the execution standby job queue 12 to the execution on-going job queue 11 for execution.

As described, the resource of a job having a low emergency level or low priority is released, and the released resource is used to execute a job having a high emergency level or high priority, according to which the job having a high emergency level or high priority can be executed immediately and the efficiency of use of license can be improved.

<Computer System>

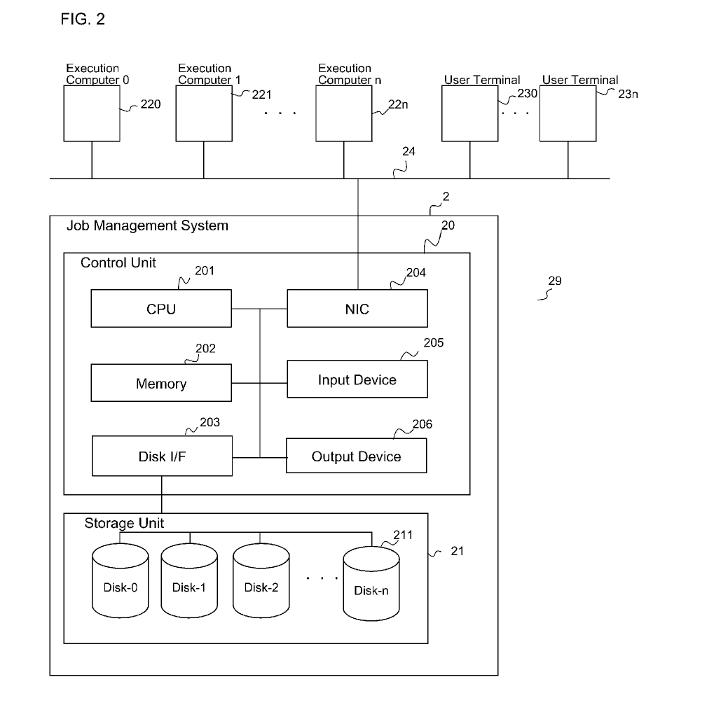

FIG. 2 is an overall configuration diagram of a computer system according to the present invention.

The computer system 29 according to the present invention includes a job management system 2 and one or more execution computers 22 (a collection of execution computers 220 through 22n), and one or more user terminals 23 (a collection of user terminals 230 through 23n). The execution computer can include two or more execution computers 220 through 22n as illustrated in the drawing. Similarly, the user terminal can include two or more user terminals 230 through 23n. A job management system 2, the execution computers 22 and the user terminals 23 are connected via a network 24 using a network protocol such as a CIFS (Common Internet File System) or a NFS (Network File System).

The job management system 2 includes a control unit 20 and a storage unit 21. The control unit 20 includes a CPU (Central Processing Unit) 201, a memory 202, a disk I/F 203, an NIC (Network Interface Card) 204, an input device 205 and an output device 206. The storage unit 21 includes a plurality of disks 211.

The CPU 201 controls the whole job management system 2.

The memory 202 has a volatile memory and/or a nonvolatile memory, and stores various information such as programs, various data and control information used by the job management system 2.

The disk I/F 203 is a controller for coupling the control unit 20 to the disks 211 of the storage unit 21.

The NIC 204 is a communication controller for connecting the job management system 2, the execution computers 22 and the user terminals 23.

The input device 205 is a means such as a keyboard or a mouse for entering queue definition information and resource management information such as resource release queue correlation definition information or queue setup information to the job management system 2.

An output device 206 is a means such as a display device or a printer for outputting information such as a job execution status or a resource use status in the job management system 2.

Although the internal configuration of the user terminals 23 are not shown, but similar to the job management system 2, each user terminal includes a CPU, a memory, a disk I/F, an NIC, an input device and an output device as the control unit, and a plurality of disks as the storage unit. Further, the queue definition information and the resource management information such as the aforementioned resource release queue correlation definition information and the queue setup information can also be entered through the input device of the user terminals 23.

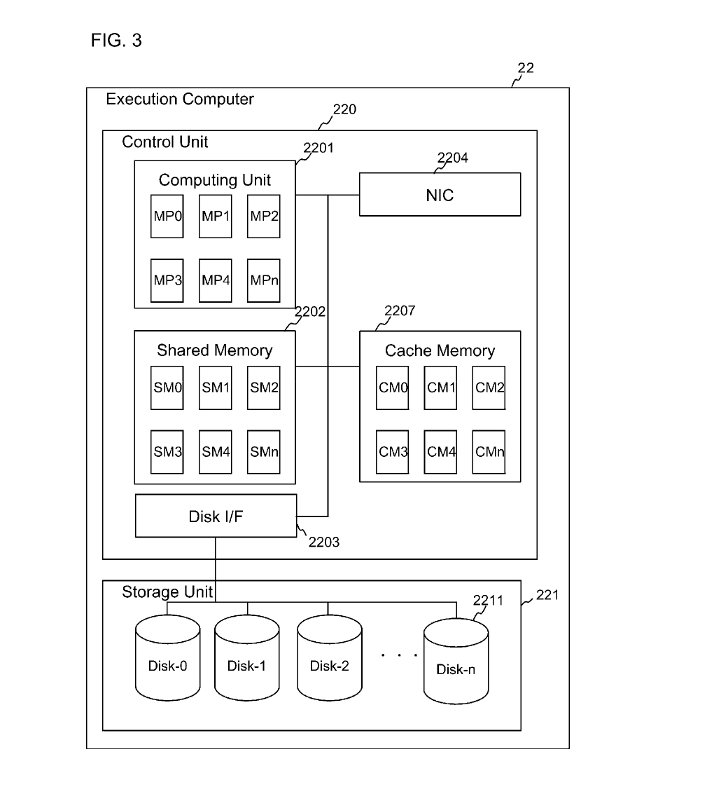

The internal configuration of the execution computers 22 is similar to the job management system 2. The detailed internal configuration thereof will be described with reference to FIG. 3.

<Execution Computer>

FIG. 3 is a configuration diagram of the execution computer of the computer system.

Each execution computer 22 includes a control unit 220 and a storage unit 221. The control unit 220 includes a computing unit 2201, a shared memory 2202, a disk I/F 2203, an NIC 2204, and a cache memory 2207. The storage unit 221 has a plurality of disks 2211.

The computing unit 2201 has a plurality of MPs (Micro Processors). Each MP is allocated in response to the execution job.

The shared memory 2202 includes a volatile memory and/or a nonvolatile memory, and stores the statuses of jobs executed by the execution computers 22 or various operation information. The shared memory has capacities required for the execution jobs allocated to the respective execution jobs.

The disk I/F 2203 is a controller for connecting the control unit 220 and the disks 2211 of the storage unit 221.

The NIC 2204 is a communication controller for connecting the execution computers 22, the job management system 2 and the user terminals 23.

The cache memory 2207 has a volatile memory and/or a nonvolatile memory, and stores the statuses of the jobs executed by the execution computers 22 or various operation information. The cache memory 2207 uses a memory device having a higher speed than the shared memory 2202, and stores data and information required to be accessed at high speed from the MP. The cache memory has capacities required for each execution job allocated to the respective execution jobs.

<Job Management System>

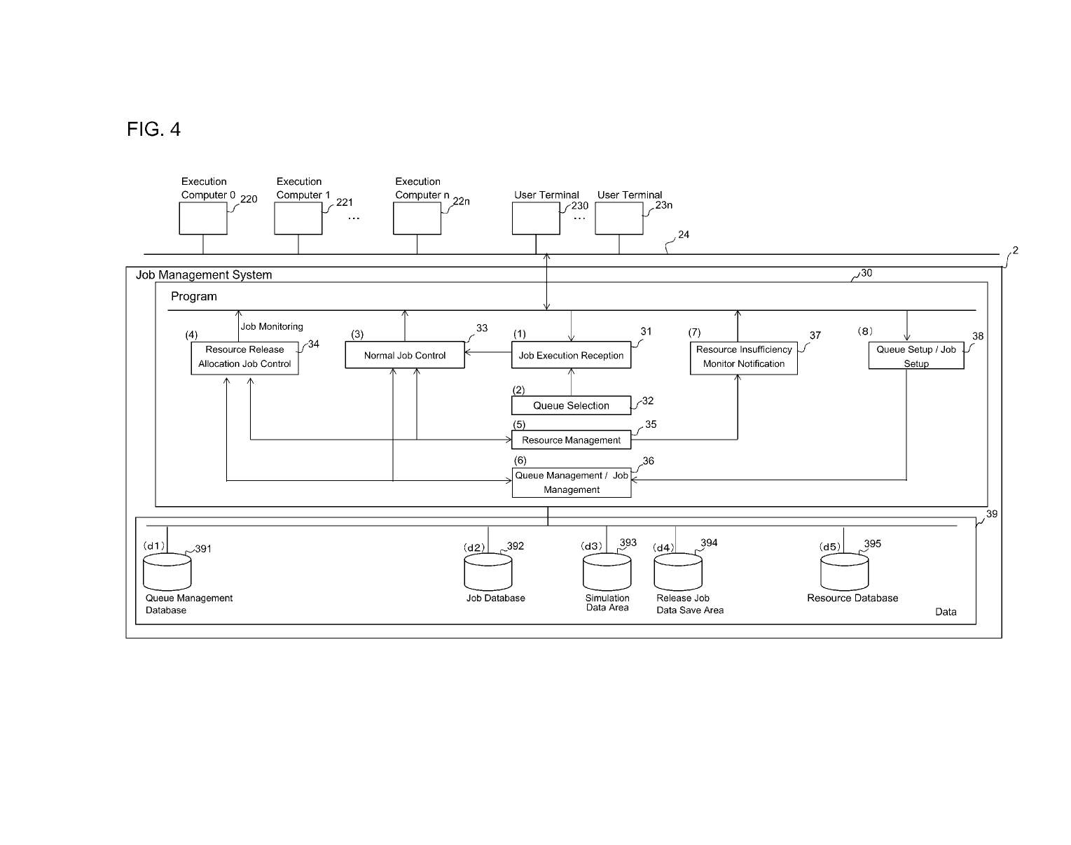

FIG. 4 is a configuration diagram of a job management system of a computer system.

A job management system 2 includes, as program 30, the following functions: (1) a job execution reception unit 31, (2) a queue selection unit 32, (3) a normal job control unit 33, (4) a resource release allocation job control unit 34, (5) a resource management unit 35, (6) a queue/job management unit 36, (7) a resource insufficiency monitor notification unit 37, and (8) a queue/job setup unit 38. The function unit constituting the program 30 is stored in the memory 202, which is read and executed via the CPU 201 when needed.

Further, data 39 includes (d1) a queue management database 391, (d2) a job database 392, (d3) a simulation data area 393, (d4) a release job data save area 394, and (d5) a resource database 395. The various data constituting the data 39 are stored in the disk 211 of the storage unit 21.

(1) Job Execution Reception Unit 31

When a job execution command is received from user terminals 23, a job execution reception unit 31 determines a job execution information via a queue selection unit based on the information related to the environment name of the simulation environment information/emergency level of the execution command, and requests the normal job control unit to execute the job. When the received job execution has all the parameters such as the queue designated manually, the job execution reception unit 31 directly requests the normal job control unit 33 to execute the job.

(2) Queue Selection Unit 32

A queue selection unit 32 determines the execution queue and the execution memory capacity based on the environment name of the simulation environment information/emergency level. A test circuit including a verification-target logical circuit is composed in which a verification model is connected to each simulation environment. Therefore, the license or the simulator of the verification model being used or the execution memory capacity is determined by the simulation environment information. Further, the corresponding queue group is determined based on the simulation environment name, and the corresponding queue is determined based on the emergency level.

(3) Normal Job Control Unit 33

A normal job control unit 33 performs a control to enter the job to the execution computers 22 considering the information on the execution computer, the resource information or the priority of the execution standby job.

(4) Resource Release Allocation Job Control Unit 34

A resource release allocation job control unit 34 determines a release job from the execution on-going job of a plurality of release target queues set for each release request queue set in a resource release queue correlation definition information, and executes releasing of the release job and re-entering of a release job.

It is determined whether a releasable job exists within the execution on-going job in order from the release target queues having the highest release priority (queues having the same priority are subjected to determination simultaneously). The order in which determination is performed to the execution on-going job is the order set in the release determination priority.

When the job of the release request queue requires release of multiple varieties of licenses, there are cases where a single job of the release target queue may not satisfy the release condition, so that the release ability is determined based on a combination of multiple jobs. If release is possible, resources of (one or more) release target jobs are released, and the resource release history is updated. If release is not possible, resource insufficiency occurrence information is updated. When releasing a resource, the resource is inactivated so as not to have the resource used by jobs of other queues, and after the release request job is executed, the state is returned.

(5) Resource Management Unit 35

The resource management unit 35 manages the state of use of the resources such as a resource insufficiency occurrence history. The resource insufficiency occurrence history is entered via job (job ID) units. The entry items referred to when detecting the exceeding of threshold are queue/insufficient license/occurrence date and time.

(6) Queue/Job Management Unit 36

The queue/job management unit 36 manages the resource release queue correlation definition information and the like referred to from the resource release allocation job control unit 34. Further, the information related to the priority of the queue or the maximum number of jobs that can be executed are also managed.

(7) Resource Insufficiency Monitor Notification Unit 37

A resource insufficiency monitor notification unit 37 monitors the resource insufficiency occurrence history, and notifies insufficiency of resource for each queue. The number of jobs in which resource insufficiency occurred within a predetermined period of time is counted, and when the number of jobs experiencing resource insufficiency exceeds a threshold, a release—allocation performance graph of a given period is created, and the number of resource insufficiency occurrence jobs/resource insufficiency occurrence graph/resource release performance graph/resource release queue correlation definition information are notified to the administrator.

When “200=24 h” and “20=1 h” is set in the resource management information, it means that “200 jobs or more in 24 hours” or “20 jobs or more in 1 hour” experienced resource insufficiency, and the result is notified to an output device or the like. The method of notification can be, for example, mail, message display, audio guidance or warning sound.

(8) Queue/Job Setup Unit 38

A queue/job setup unit 38 executes setting of queues, setting of resource release queue correlation definition information, and setting of resource management information. Further, a plurality of release target queues and the order of priority of the execution of release are set with respect to the release request queues. As release determination priority, “stop/re-execution”, “interruption/resumption” or “execution time” is set.

The setting of the resource management information has a function to set up a threshold value of resource insufficiency via a command or via screen manipulation. It further has a screen and a command for displaying feedback information (graph of resource insufficiency status or resource release status) for improving the resource use efficiency.

(d1) Queue Management Database 391

The queue management database 391 stores resource release queue correlation definition information, queue setup information and resource management information.

(d2) Job Database 392

Execution job information is stored in the job database 392.

(d3) Simulation Data Area 393

A simulation data area 393 stores simulation environment information and simulation test information.

(d4) Release Job Data Save Area 394

A release job data save area 394 stores the result of execution of the interrupted job until interruption.

(d5) Resource Database 395

A resource database 395 stores the resource information, the resource insufficiency occurrence history and the resource release history.

The details of the various information mentioned above will be described later.

<<Various Commands and Information>>

<Execution Command>

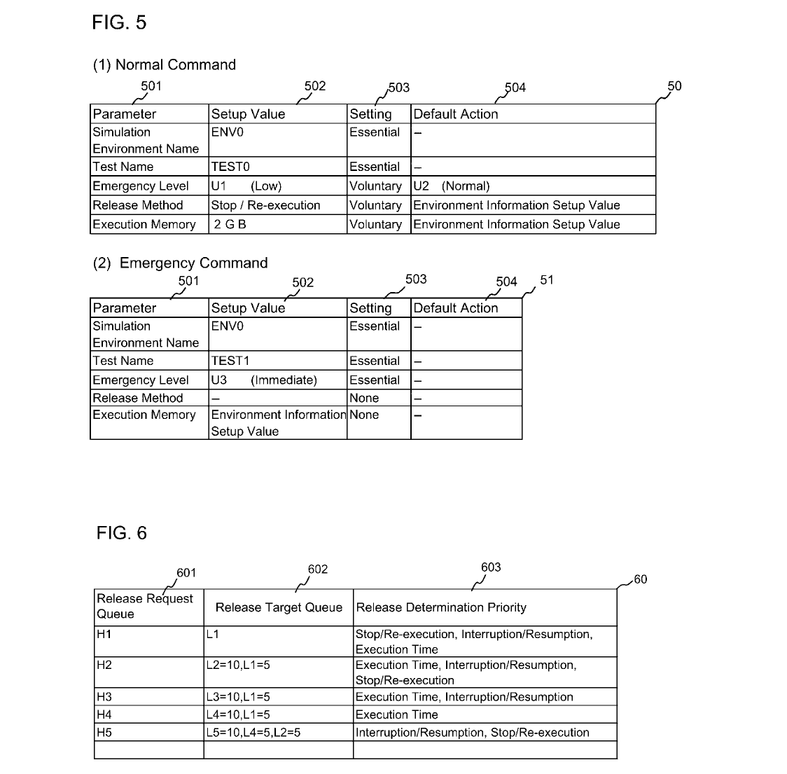

FIG. 5 is a view showing a configuration example of an execution command There are two types of execution commands; (1) a normal command, and (2) an emergency command One example of the normal command is a job execution command for regression, which is executed when changing the logic of the LSI. Similarly, one example of the emergency command is an execution command for confirming bug countermeasures of the LSI that requires immediate response.

(1) Normal Command 50

A normal command 50 includes a parameter 501, a setup value 502, a setting 503, and a default action (setup action of default value) 504.

A parameter 501 has various entries including a simulation environment name, a test name, an emergency level (urgency), a release method and an execution memory.

An environment name for executing simulation, such as “ENV0”, is set in the setup value 502 of the simulation environment name. Since the setting of the simulation environment name is “essential” (the content of setting 503 is “essential”), so that there is no default action 504.

An ID for identifying a test, such as “TEST0”, is set in the setup value 502 of the test name. Since the setting of the test name is “essential”, there is no default action 504.

An emergency level of the job to be executed is set in the setup value 502 of the emergency level. Since the setting of the setup value 502 of the emergency level is “voluntary”, it can either be set or not set. If it is not set, “U2 (normal)” is set based on the default action 504. In the present drawing, the value is set to “U1 (low)”.

The setup value 502 of the release method is selected from “stop/re-execution”, “interruption/resumption” and “execution time”. The setup value 502 of the release method is set to “voluntary”. If a value is not set in the setup value 502, the setup value in the simulation environment information described later will be selected.

A memory capacity required for executing a job is designated in the setup value 502 of the execution memory. The setting of the setup value 502 of the execution memory is “voluntary”, so that it can either be set or not set. If the value is not set in the setup value 502, the setup value in the simulation environment information mentioned later will be selected.

(2) Emergency Command 51

An emergency command 51 includes a parameter 501, a setup value 502, a setting 503 and a default action 504.

The simulation environment name, the test name and the execution memory are the same as the job execution normal command 50.

The setup value 502 of the emergency level is set to “essential”, and the value is set to “U3 (immediate)”.

The setup value 502 of the release method is not necessary, since release is unnecessary.

<Resource Release Queue Correlation Definition Information>

FIG. 6 is a view illustrating a resource release queue correlation definition information.

Unlike the prior art technique in which jobs are entered based on the priority of the execution standby jobs, the present invention performs control to release the resource of a job having a low emergency level and allocate the same to immediately execute the job having a high emergency level. Therefore, a resource release queue correlation definition information 60 is used to determine which job can be released by the job requiring release of a resource. The resource release queue correlation definition information 60 is stored in a queue management database 391.

The resource release queue correlation definition information 60 includes a release request queue 601, a release target queue 602, and a release determination priority 603. The release target queue 602 includes a release target queue type and release queue priority.

The release request queue 601 is defined from “H5” to “H1”, and for each release request queue are set a release target queue 602 and a release determination priority 603. For example, the release target queue 602 with respect to the queue in which the release request queue 601 is “H1” is “L1”, and the release determination priority 603 selects a queue to be released in the order of “stop/re-execution” and “interruption/resumption”.

Further, the release target queues with respect to a queue in which the release request queue 601 is “H2” are “L1” and “L2”. The queues “L1” and “L2” have values “10” and “5” set as release queue priority, so that “L2” having a larger value is set as the initial release target queue. Further, if there are multiple queues having the same release queue priority, the multiple queues are set as release target queues subjected to simultaneous job check. If there are a plurality of execution on-going jobs in the release target queues, the release target job is narrowed down by the contents of settings the release determination priority 603, that is, by the execution time.

<Queue Setup Information>

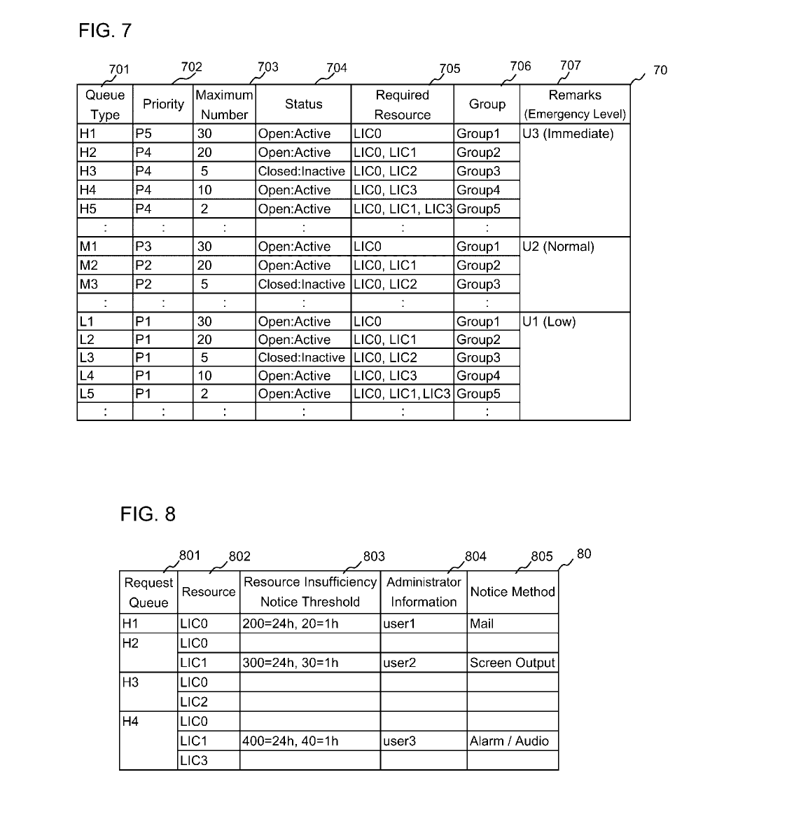

FIG. 7 is a view showing a queue setup information. A queue setup information 70 is stored in the queue management database 391.

The queue setup information 70 includes a queue type 701, a priority 702, a maximum number of use 703, a status 704, a required resource 705, a queue group 706, and an emergency level 707.

A queue type 701 is classified into H1 through H5 in which the emergency level 707 is “U3 (immediate)”, M1 through M5 (not shown) in which the emergency level is “U2 (normal)”, and L1 through L5 in which the emergency level is “U1 (low)”. The jobs having an emergency level “U3 (immediate)” are jobs that are to be executed immediately even by depriving resources from other jobs.

The jobs having an emergency level “U2 (normal)” are jobs that are desired to be executed in the order of priority (which can wait if there is no vacant resource, but do not want to be interrupted or stopped).

The jobs having an emergency level “U1 (low)” are jobs that are to be executed during the resource vacant time zone (that can be interrupted or stopped to surrender a resource to a job having a high emergency level, and then re-entered).

Queues Hx store jobs that must be executed immediately, such as a bug countermeasure confirmation job or a job for verifying a new function of the LSI.

Queues Mx store jobs that do not want to be interrupted or stopped, such as a job for controlling execution of simulation by changing various parameters in a simulation environment in which various controllers are connected.

Queues Lx store jobs that can be stopped or interrupted, such as a job for verifying the logic when the logic is changed (regression test).

The priority 702 has five levels, from P5 to P1. The priority order within the same queue level is determined using this priority. For example, the priority of queue H1 is highest, which is P5, and the priority of H2 has a priority P4, the priority of which is one level lower than H1. Therefore, when jobs are entered simultaneously to queue H1 and queue H2, the job entered to queue H1 is executed first based on the priority.

The maximum number of use 703 represents the maximum number of jobs capable of being executed in each queue.

There are four statuses in status 704, which are “Open”, “Closed”, “Active” and “Inactive”.

An “Open” state refers to the state allowing a job to be entered. A “Closed” state refers the state inhibiting the entry of a job.

An “Active” state refers to the state where execution is possible when an execution standby job is changed to an executable state. An “Inactive” state refers to the state where execution is not possible even when an execution standby job is changed to an executable state, that is, a frozen state.

The required resource 705 refers to the types of software licenses required for executing jobs that are to be executed in each queue. For example, queue H1 only requires “LIC0”, whereas queue H2 requires “LIC1” in addition to “LIC0”. Incidentally, FIG. 13 illustrates the assembled license information. FIG. 13 will be described later.

The queue group 706 is information for distinguishing the grouped queues, which is used for example by the simulation environment information.

The emergency level 707 is selected from “U3 (immediate)”, “U2 (normal)” and “U1 (low)” by the job execution command Especially in the development of a large-scale LSI used for example in large-scale computer systems and storage systems, it is necessary to execute a large amount of verification jobs for a long period of time. Efficient job control becomes necessary, so the above-described emergency level is used to perform job control.

<Resource Management Information>

FIG. 8 is a view showing a resource management information. A resource management information 80 is stored in the queue management database 391.

The resource management information 80 includes a release request queue 801, a request resource 802, a resource insufficiency notice threshold 803, an administrator information 804, and a notice method 805.

A release request queue 801 is information for identifying a queue for requesting release.

A request resource 802 is information for identifying resources that require release.

A resource insufficiency notice threshold 803 is a threshold for determining whether the number of jobs having insufficient resources required for each queue has reached a given value within a given period of time.

For example, regarding LIC0 in which the release request queue is H1, if the resource becomes insufficient for 200 times or more within 24 hours or 20 times or more within one hour, resource insufficiency is notified via “mail” set as the notification method 805 to “user1” set in the administrator information 804. Other notification methods include, in addition to mail, an output of a message on a screen of the output device 206, or an output of a warning sound or audio.

<Simulation Environment Information>

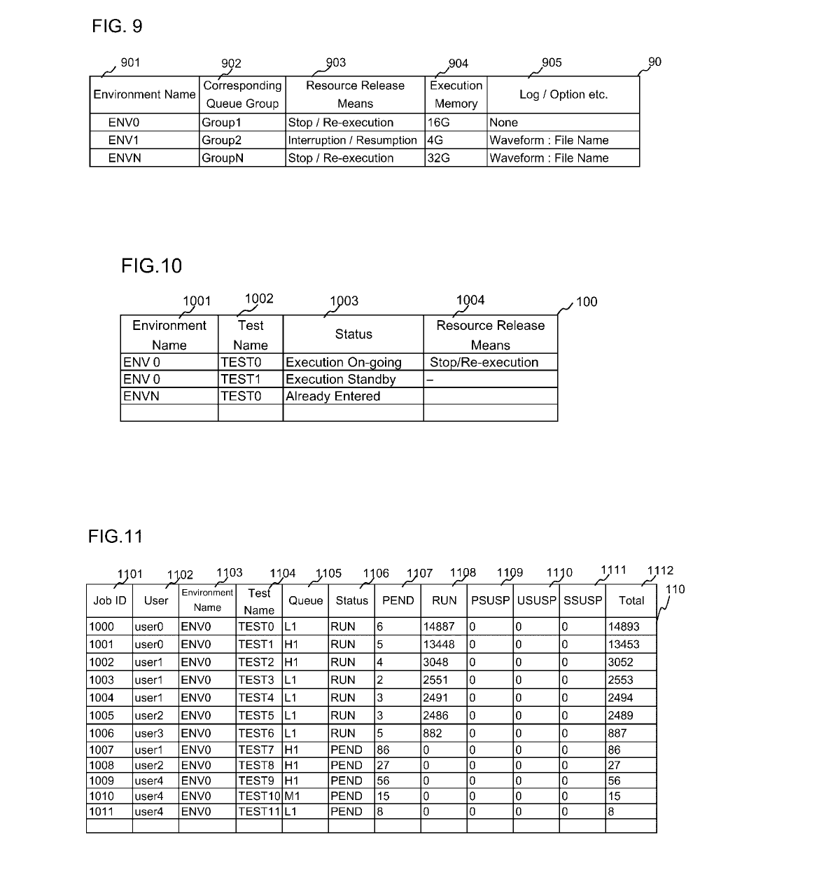

FIG. 9 is a view illustrating a simulation environment information. A simulation environment information 90 is stored in the job database 392.

The simulation environment information 90 sets up an environment information in which simulation is executed, which includes a simulation environment name 901, a corresponding queue group 902, a resource release means 903, an execution memory 904, and a log/option etc. 905.

A simulation environment name 901 is information for identifying the environment for executing the simulation (job). Now, the execution job is described as simulation.

A corresponding queue group 902 is the information for identifying a queue for executing simulation. The corresponding queue group is determined by the simulation environment name in the execution command The corresponding queue group and the emergency level of the execution command are checked against the queue setup information 70 to determine the corresponding queue.

A resource release means 903 sets up a release means of the resource with respect to the job of the release target queue, which is selected from either “stop/re-execution” or “interruption/resumption”. The setup of the resource release means 903 is performed using a setup command or an input screen.

According to “stop/re-execution”, the simulation is stopped, that is, ended, and the resource is released. Then, when a resource is re-acquired, the simulation is executed from the beginning.

According to “interruption/resumption”, the simulation is temporarily interrupted, and the result of executing simulation up to the interrupted point is saved and stored in the release job data save area 394. Then, when a resource is re-acquired, the simulation execution result saved in the release job data save area 394 is read out, and the simulation is resumed from the interrupted point. If the resource release means 903 is not set, “stop/re-execution” is set up as a default to the resource release means 903.

An execution memory 904 sets a capacity of the shared memory 2202 of the execution computers 22 or the like required to execute the simulation, and “4 GB” is set as a default value.

A log/option etc. 905 sets up the method for outputting the log of the simulation or whether to output the waveform of the execution result or not.

<Simulation Test Information>

FIG. 10 is a view showing a simulation test information. The simulation test information 100 is stored in the job database 392.

The simulation test information 100 stores the information on the state of execution of each simulation test, and includes a simulation environment name 1001, a simulation test name 1002, a status 1003 and a resource release means 1004.

A simulation environment name 1001 stores an environment name in which the simulation test is executed. The setup value 502 corresponding to the entry of the simulation environment name in the parameter 501 of the normal command 50 or the emergency command 51 is stored in the simulation environment name 1001.

A simulation test name 1002 stores the information for identifying each test. The information of the setup value 502 corresponding to the entry of the test name in the parameter 501 of the normal command 50 or the emergency command 51 is stored in the simulation test name 1002.

A status 1003 stores the states of execution of jobs of the simulation test, which are selected from “execution on-going”, “execution standby” and “already entered”. The “already entered” state shows that a job has been entered but the state has not been transited to an “execution on-going” state or an “execution standby” state.

A resource release means 1004 stores the information of the setup value 502 corresponding to the entry of the release method in the parameter 501 of the normal command 50. If the information of the setup value 502 corresponding to the entry of the release method is not set, the content set in the resource release means 903 of the simulation environment information 90 is stored in the resource release means 1004. The content of the job execution command is reflected in the setup of the resource release means 1004.

FIG. 11 is a view showing an execution job information. The execution job information 110 is stored in the job database 392. The execution job information 110 is information for managing the state of the execution on-going or execution standby job entered to the queue.

The execution job information 110 includes a job ID 1101, a user 1102, a simulation environment name 1103, a test name 1104, a queue 1105, a status 1106, a PEND 1107, a RUN 1108, a PSUSP 1109, a USUSP 1110, a SSUSP 1111, and a total 1112.

A job ID 1101 stores information for identifying jobs, wherein a sequential number is provided to jobs based on the order in which the jobs are entered.

A user 1102 is information for identifying the user that entered the job from the user terminal 23.

A simulation environment name 1103 and a test name 1104 stores the simulation environment name and the test name in the parameter 501 of the normal command 50 or the emergency command 51.

A queue 1105 stores a queue to be executed. The content of the queue 1105 is determined by the corresponding queue group 902 specified by the simulation environment name 1103 and the simulation environment information 90 and the emergency level entered to the parameter 501 of the normal command 50 or the emergency command 51 referring to the queue setup information 70.

A job having “1000” as the job ID 1101 and “TEST0” as the test name 1104 has the simulation environment name 1103 set to “ENV0”, and based on the simulation environment information 90, the corresponding queue group 902 can be specified as “Group1”. Further, based on the specified corresponding queue group “Group1” and the emergency level “U1 (low)”, and by referring to the queue setup information 70, the queue can be specified as “L1” (refer to FIG. 5(1) normal command 50).

Similarly, a job in which the job ID 1101 is “1001” and a test name 1104 is “TEST1” has the simulation environment name 1103 set to “ENV0”, and based on the simulation environment information 90, the corresponding queue group 902 can be specified as “Group1”. Furthermore, by referring to the queue setup information 70 based on the specified corresponding queue group “Group1” and the emergency level “U3 (immediate)”, the queue can be specified as “H1” (Refer to FIG. 5(2) emergency command 51).

A status 1106 is the information indicating the execution status of the entered job, which is selected from the following two statuses; “RUN” indicating an execution on-going state, and “PEND” indicating an execution standby state.

PEND 1107 shows the execution standby time (sec) of a job.

RUN 1108 shows an execution time (sec) of a job.

PSUSP 1109 shows a time (sec) in which the simulation job has been suspended by the control program of the job management system 2.

USUSP 1110 shows a time (sec) in which the simulation job has been suspended by the user.

SSUSP 1111 shows a time (sec) in which the simulation job has been suspended by the job management system 2.

Total 1112 shows the total time from PEND 1107 to SSUSP 1111.

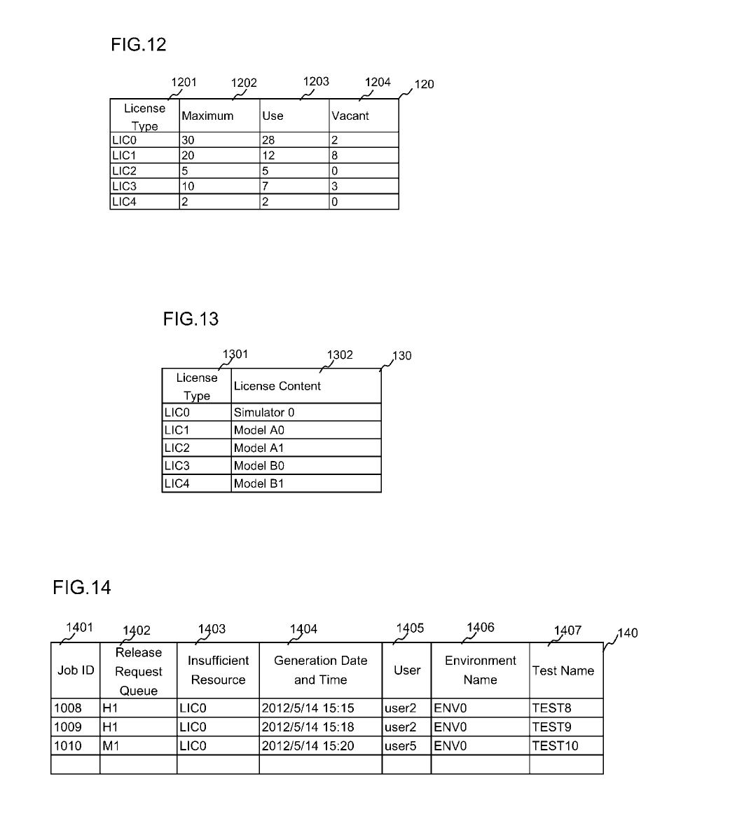

FIG. 12 shows a resource information. FIG. 13 shows a license information. The resource information 120 is stored in the resource database 395.

The resource information 120 includes a maximum number of licenses 1202 that can be used for each license type 1201, a number of licenses 1203 being used, and a number of vacant licenses 1204. For example, it can be seen from resource information 120 that the license in which the license type 1201 is “LIC0” has a maximum number “30”, wherein “28” licenses are being used and “2” licenses are vacant (unused) licenses.

The license information 130 is information showing the contents of the license 1302 for each license type 1301. For example, license “LIC0” is “Simulator0” which is a simulator body, license “LIC1” is a model used by the simulator, which can be, for example, a bus model such as a PCI-e (Registered Trademark), or a verification IP such as a memory module model, various controller models, or a serial I/F model. The job management system 2 uses the resource information 120 to have one or more simulation jobs executed via the execution computers 22. At this time, the job management system 2 can have a job having combined the aforementioned respective simulators and multiple models (verification IPs) executed in parallel via the execution computers 22.

FIG. 14 is a view showing a resource insufficiency occurrence history. A resource insufficiency occurrence history 140 is stored in the resource database 395.

The resource insufficiency occurrence history 140 manages the resource insufficiency that has occurred in each job stored in the release request queue. The resource insufficiency occurrence history 140 includes a job ID 1401, a release request queue 1402, an insufficient resource 1403, a generation date and time 1404, a user 1405, a simulation environment name 1406, and a test name 1407.

A job ID 1401 is the information identifying the job in execution standby state.

A release request queue 1402 is the information for identifying the queue of a job in execution standby state.

An insufficient resource 1403 is the information on the resource being insufficient (being required) in execution standby state.

A generation date and time 1404 is the information on the date and time in which resource insufficiency has occurred.

A user 1405, a simulation environment name 1406 and a test name 1407 are the same as those of FIG. 11 mentioned earlier.

Further, the history update when resource insufficiency has occurred is overwritten to the same job ID, and the elapse information is not saved in the resource database 395.

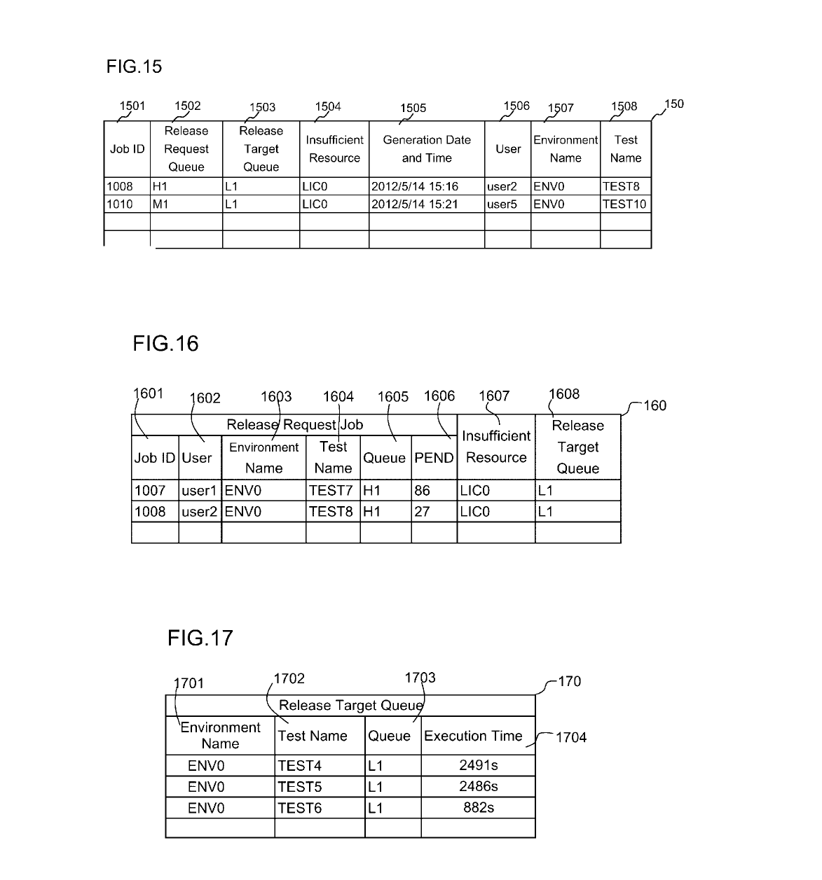

FIG. 15 is a view showing a resource release history. The resource release history 150 is stored in the resource database 395.

The resource release history 150 manages the released resource information based on the job in execution standby state stored in the release request queue. The resource release history 150 includes a job ID 1501, a release request queue 1502, a release target queue 1503, an insufficient resource 1504, a generation date and time 1505, a user 1506, a simulation environment name 1507, and a test name 1508.

A release request queue 1502 in which the specified job ID 1501 is stored corresponds to a release target queue 1503 and an insufficient resource (release resource) 1504. For example, it can be seen from resource release history 150 that the job in which the job ID 1501 is “1008”, the release request queue 1502 is “H1”, the release target queue 1503 is “L1” and the insufficient resource (release resource) 1504 is “LIC0” was released at generation date and time 1505 of “2012/5/14 15:16”.

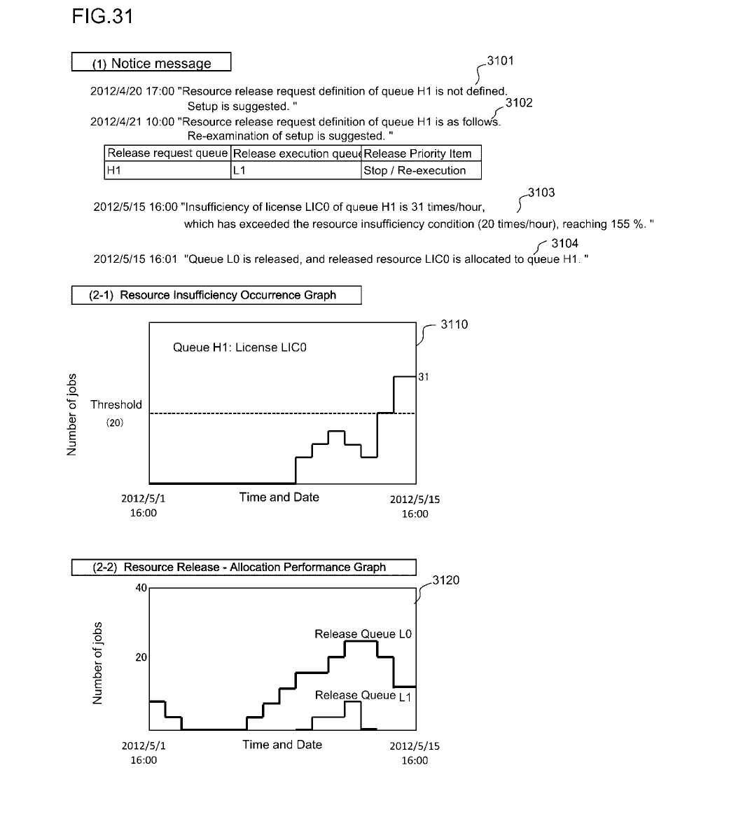

The resource insufficiency occurrence history 140 and the resource release history 150 can be displayed as a time-series insufficiency occurrence graph/release performance graph on the output device of the job management system 2. The details will be described later (FIG. 31).

FIG. 16 is a view showing a resource release request job list. A resource release request job list 160 is stored in the resource database 395.

The resource release request job list 160 is a list showing the state of the release request job. The resource release request job list 160 includes a job ID 1601, a user 1602, a simulation environment name 1603, a test name 1604, a release request queue 1605, a PEND time (execution standby time) 1606, an insufficient resource 1607, and a release target queue 1608. Further, the resource release request job list 160 aligns jobs from those having a long PEND time (execution standby time) 1606 to those having a short (small) time.

FIG. 17 is a view showing a release target queue list. A release target queue list 170 is stored in the resource database 395.

The release target queue list 170 is a list showing the status of the release target queue. The release target queue list 170 includes a simulation environment name 1701, a test name 1702, a queue 1703, and an execution time 1704.

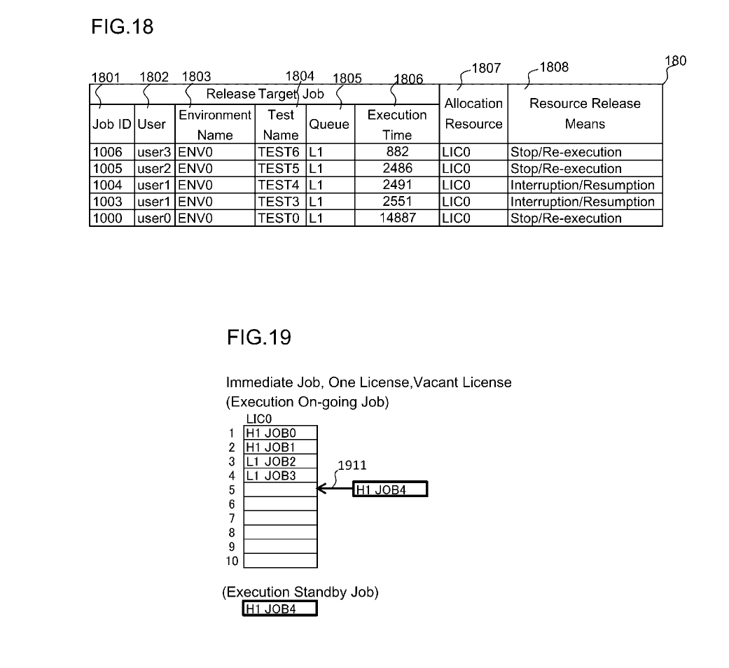

FIG. 18 is a view showing a release target job list. A release target job list 180 is stored in the resource database 395.

The release target job list 180 is information showing the statuses of release target jobs. The release target job list 180 includes a job ID 1801, a user 1802, a simulation environment name 1803, a test name 1804, a release target queue 1805, an execution time 1806, an allocation resource 1807, and a resource release means 1808. The release target job list 180 has aligned jobs from jobs having a shorter (smaller) execution time 1806 to those having a longer (greater) execution time.

<<Release of Resource and Job Replacement>>

<Replacement Operation 1>

Next, we will describe the operation of the release of resource of the execution on-going job and the replacement of the execution job. The process is mainly performed by the resource release allocation job control unit 34, but it can also be performed by the CPU 201.

Now, it is assumed that the maximum number of use of license LIC0 is 10, and the maximum number of use of licenses LIC1 and LIC3 are each 5. Further, it is assumed that the jobs arranged on the upper side of the job queue have longer execution times.

FIG. 19 is a view showing a first job replacement operation when an immediate job is entered. The number of jobs in execution status using license LIC0 is four, and in this state, it is assumed that a JOB4 of queue H1 which is a new immediate job (shown as H1JOB4) is entered. The license LIC0 has six vacant areas, so that H1JOB4 can be executed immediately as shown by reference number 1911. In such case, the job is performed not by the resource release allocation job control unit 34 but by the normal job control unit 33.

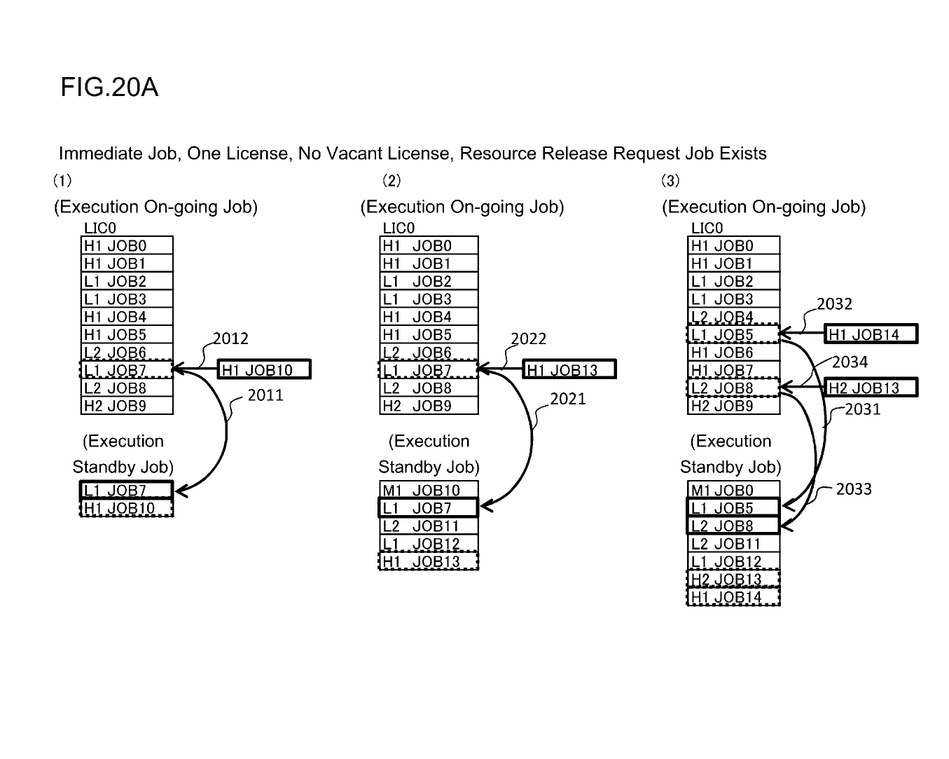

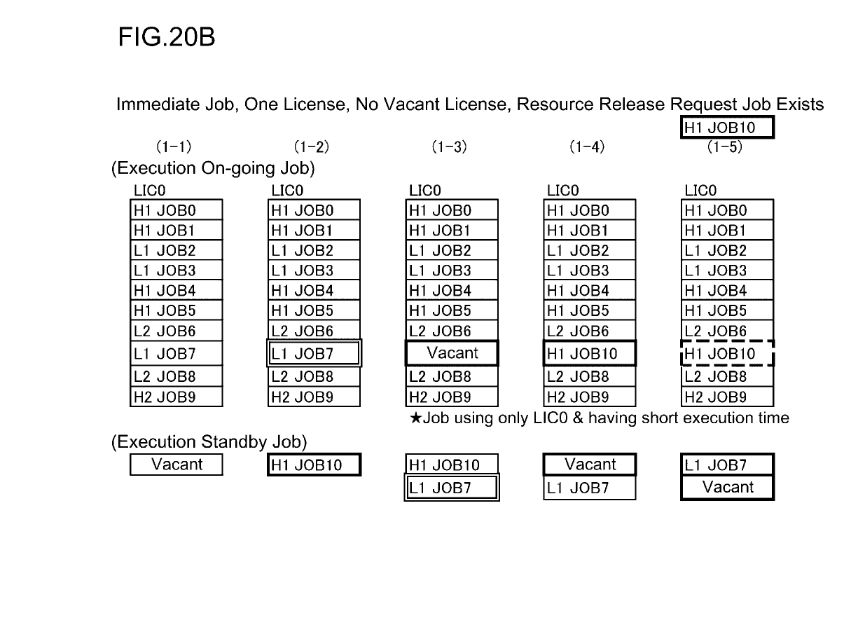

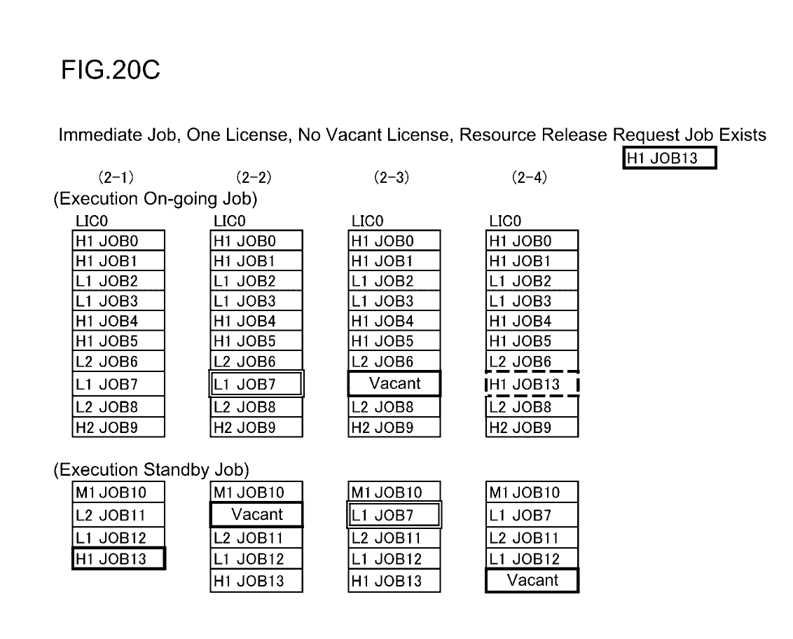

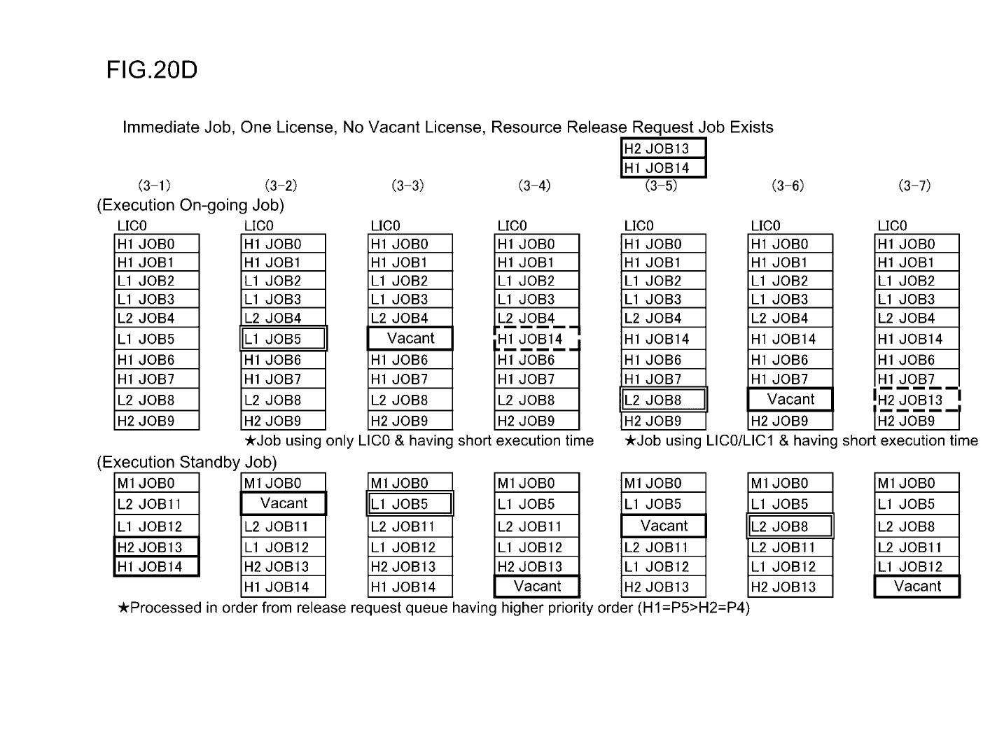

FIG. 20A is a view showing a first job replacement operation when an immediate job is entered. In FIG. 20A(1), the number of jobs in execution status using license LIC0 is 10, and in this state, it is assumed that H1JOB10 is newly entered. In this state, H1JOB10 cannot be executed unless a resource of another job is released.

Therefore, the resource release allocation job control unit 34 temporarily stores the H1JOB10 in the execution standby job queue. Regarding queue H1, since queue L1 can be released based on the resource release queue correlation definition information 60, the resource release allocation job control unit 34 selects jobs L1JOB2, L1JOB3 and L1JOB7.

The resource release allocation job control unit 34 selects a job having a short execution time (positioned on the bottom of the job queue) out of the selected jobs. As a result, a job L1JOB7 having a resource (license LIC0) released is selected. The resource release allocation job control unit 34 either interrupts or stops the execution of job L1JOB7 as shown in reference number 2011, moves the job to the execution standby job queue, and releases the resource.

The resource release allocation job control unit 34 allocates the released resource to the job H1JOB10, and as shown in reference number 2012, enters the job to the execution on-going job queue and sets the same to execution standby. Incidentally, the newly entered job H1JOB10 has the shortest execution time, so that the resource release allocation job control unit 34 allocates the job after job H2JOB9 which is on the bottom of the execution on-going job queue.

As described, by allocating a resource of an execution on-going job of the release target queue to an execution standby job of the queue requesting release of resource, it becomes possible to immediately execute jobs having a high emergency level.

FIG. 20A(2) shows a state in which the number of jobs in execution state using license LIC0 is 10, similar to FIG. 20A(1), and in that state, it is assumed that H1JOB13 which is an immediate job is newly entered. The job replacement operation is the same as FIG. 20A(1), but the destination of movement of the L1JOB7 having released the resource to the execution standby job queue differs.

At first, the resource release allocation job control unit 34 places the newly entered job H1JOB13 behind the M1JOB10, L2JOB11 and L1JOB12 in the execution standby job queue. Then, after the resource of the job L1JOB7 is released, the resource release allocation job control unit 34 enters the job H1JOB13 to the execution on-going job queue as shown in reference number 2022, and the job is executed.

Next, the resource release allocation job control unit 34 moves the job L1JOB7 to the head of the jobs of queues L1 and L2 having the same priority “P1” as shown by the reference number 2021. That is, the job execution standby order is as follows; M1JOB10, L1JOB7 (resource release job), L2JOB11 and L1JOB12, and the resource release allocation job control unit 34 performs a priority control so that the job having the resource released during execution on-going is resumed or re-executed in a prioritized manner

Similar to FIG. 20A(2), the number of jobs in execution status using license LIC0 in FIG. 20A(3) is 10, and in this state, it is assumed that immediate jobs, H2JOB13 and H1JOB14, are entered simultaneously.

At first, the resource release allocation job control unit 34 compares the priority “P4” of job H2JOB13 and the priority “P5” of job H1JOB14, and the execution processing of job H1JOB14 having a high priority “P5” is executed with priority.

Next, the resource release allocation job control unit 34 replaces L1JOB5 having the shortest execution time with job H1JOB14 out of the jobs in which the queue using only license LIC0 is L1, as shown in reference numbers 2031 and 2032. Also according to this case, the resource release allocation job control unit 34 arranges the job L1JOB5 having the resource released to the execution standby job queue with higher priority than the queue having the same priority P1, as shown in FIG. 20A(2).

Next, the resource release allocation job control unit 34 selects an execution on-going job candidate having licenses LIC0 and LIC1 required by the job H2JOB13. The job candidates are L2JOB4 and L2JOB8, and the resource release allocation job control unit 34 selects a job L2JOB8 having a short execution time, and the replacement of jobs is executed as shown in reference numbers 2033 and 2034.

As described, the control of the releasing of resource and job replacement is executed by the resource release allocation job control 34 using the resource release queue correlation definition information 60.

FIG. 20B is a view showing a detailed operation 1 of the first job replacement when an immediate job is entered. FIG. 20C is a view showing a detailed operation 2 of the first job replacement when an immediate job is entered. FIG. 20D is a view showing a detailed operation 3 of the first job replacement when an immediate job is entered.

FIGS. 20B through 20D show the control of the releasing of resource and job replacement from FIGS. 20A(1) to 20A(3) in time-series.

<Replacement Operation 2>

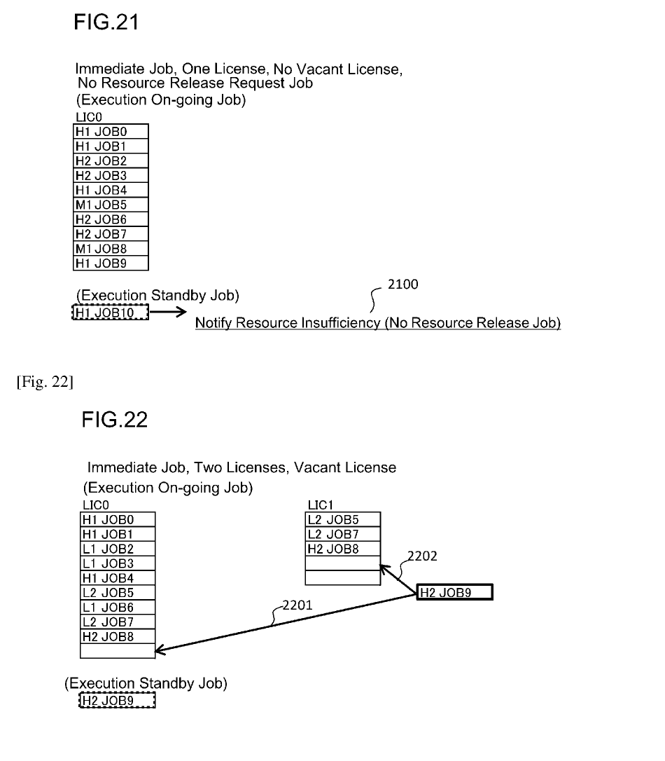

FIG. 21 is a view showing a second job replacement operation when an immediate job is entered.

In FIG. 21, it is assumed that a new job H1JOB10 is entered in a state where the number of jobs in execution status using license LIC0 is 10, and there are no vacant licenses. Regarding the release request queue H1 of job H1JOB10, the release target queue is not defined in the resource release queue correlation definition information 60.

In this state, it is not possible to release the resource of the execution on-going job and execute job replacement. Therefore, the resource release allocation job control 34 notifies this state to a resource insufficiency monitor notice 37, and a resource insufficiency notice message or the like are displayed on the output device 206. The details will be illustrated later (FIG. 31). Further, even if the release target queue with respect to the release request queue H1 of the job H1JOB10 is defined in the resource release queue correlation definition information 60, a similar process is performed if an execution on-going job does not exist.

<Replacement Operation 3>

FIG. 22 is a view showing a third job replacement operation when an immediate job is entered.

The number of execution on-going jobs using license LIC0 is nine, the number of execution on-going jobs using license LIC1 is three, and in this state, it is assumed that a JOB9 of queue H2 which is a new immediate job (referred to as H2JOB9) is entered.

Since there are vacancies in license LIC0 and license LIC1, the H2JOB9 can be executed immediately as shown in reference numbers 2201 and 2202. In that case, the job is processed not by the resource release allocation job control unit 34 but by the normal job control unit 33.

<Replacement Operation 4>

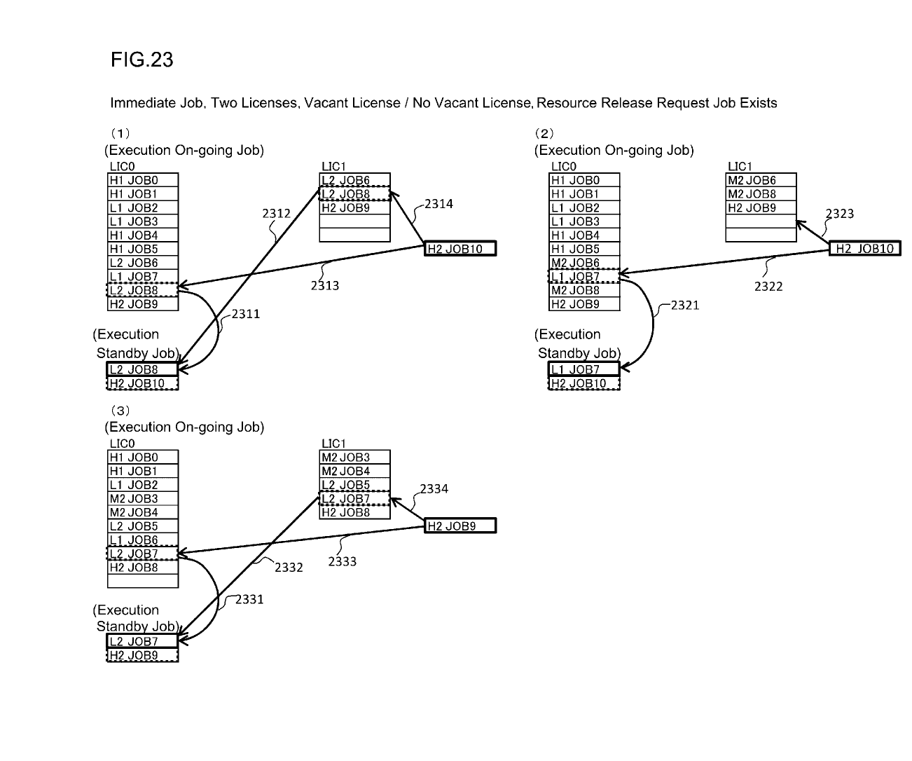

FIG. 23 is a view showing a third job replacement operation when an immediate job is entered. In the example of FIG. 23, it is assumed that an immediate job H2JOB9 (release request queue H2) requiring licenses LIC0 and LIC1 is newly entered.

<License LIC0 Insufficiency 1>

At first, FIG. 23(1) shows an example in which there are two vacant licenses in license LIC1 and no vacant licenses in license LIC0. Therefore, in order to enable execution of job H2JOB10, the resource release allocation job control 34 uses license LIC0 to release the resource of an execution on-going job. At first, from the content “L2=10, L1=5” of the release target queue 602 of the resource release queue correlation definition information 60, the resource release allocation job control 34 selects a queue L2 having a high priority “10” as the release target queue candidate, and selects L2JOB8 having the shortest execution time.

Then, the resource release allocation job control 34 moves the job L2JOB8 to the execution standby job queue as shown in reference numbers 2311 and 2312, releases the licenses LIC0 and LIC1 and allocates the same to job H2JOB10. The job H2JOB10 having allocated thereto the released licenses LIC0 and LIC1 are stored in the execution job queue LIC0 and LIC1 and set to execution state as shown in reference numbers 2313 and 2314 by the resource release allocation job control 34.

<License LIC0 Insufficiency 2>

FIG. 23(2) illustrates an example in which license LIC0 has no vacant licenses, similar to FIG. 23(1), but license LIC1 has two vacant licenses. Therefore, the resource release allocation job control 34 releases the license LIC0 (resource) used by the execution on-going job so as to enable execution of job H2JOB10.

At first, based on the content “L2=10, L1=5” of release target queue 602 of the resource release queue correlation definition information 60, the resource release allocation job control 34 sets queue L2 having a high priority “10” as the release target queue candidate. However, since the job of L2 queue is not executed, it is not possible to release the resource. Therefore, the resource release allocation job control 34 sets the queue L1 having priority “5” as the release target queue candidate. There are three jobs in queue L1, which are L1JOB2, L1JOB3 and L1JOB7.

Therefore, the resource release allocation job control 34 extracts a job that can release a resource based on the execution time from the content of “execution time, interruption/resumption, stop/re-execution” of the release determination priority 603 of the resource release queue correlation definition information 60.

The resource release allocation job control 34 sets the job L1JOB7 having the shortest execution time as the resource release target. Then, the resource release allocation job control 34 moves the job L1JOB7 to the execution standby job queue as shown by reference number 2321, and releases the license LIC0 and allocates the same to the job H2JOB10.

The job H2JOB10 having the released license LIC0 allocated thereto is stored in execution job queue LIC0 and LIC1 by the resource release allocation job control 34 as shown in reference numbers 2322 and 2323, and set to execution status.

<License LIC1 Insufficiency>

FIG. 23(3) shows an example in which there is no vacant license in license LIC1. The releasing of resource and replacing of jobs is performed in the case of FIG. 23(3), Similar to FIG. 23(2).

The resource release allocation job control 34 sets the job L2JOB7 having the shortest execution time in the execution on-going job using license LIC1 as the resource release target. Then, the resource release allocation job control 34 moves the job L2JOB7 to the execution standby job queue as shown in reference numbers 2331 and 2332, and the licenses LIC0 and LIC1 are released and allocated to job H2JOB9.

The job H2JOB9 provided the released license LIC1 is stored in execution job queues LIC0 and LIC1 as shown in reference numbers 2333 and 2334 by the resource release allocation job control 34, and set to execution status.

<Replacement Operation 5>

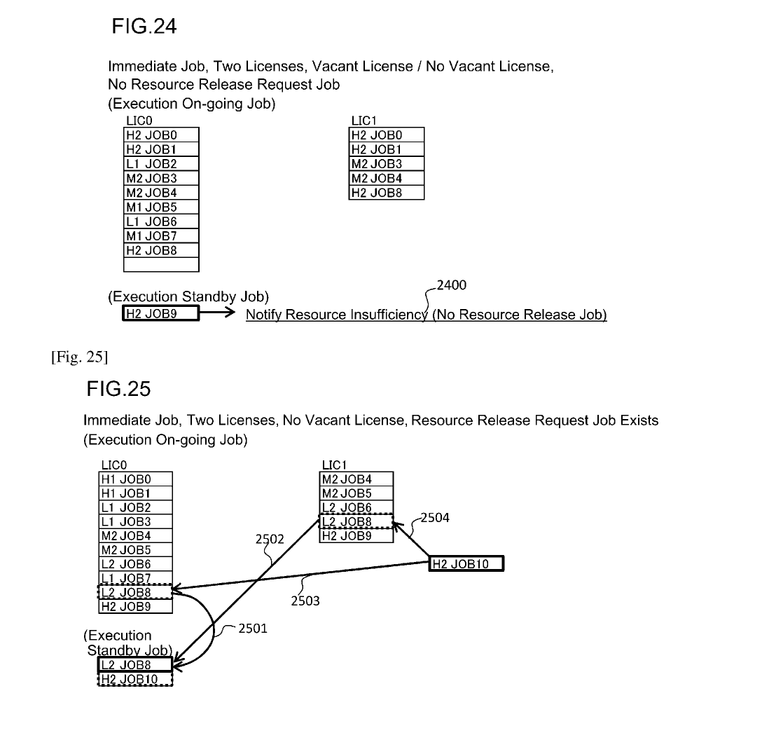

FIG. 24 is a view showing a fifth job replacement operation when an immediate job is entered.

In FIG. 24, license LIC0 is used, wherein the number of execution on-going jobs is nine and the number of vacant license is one. However, license LIC1 is also used, wherein the number of execution on-going jobs is five and there are no vacant licenses. Further, regarding the release request queue H2 of the newly entered job H2JOB9, the release target queue that can be released is not defined in the resource release queue correlation definition information 60.

In this state, it is not possible to release the resource of the execution on-going job and to execute job replacement. Therefore, the resource release allocation job control 34 notifies this status to the resource insufficiency monitor notice 37, and the resource insufficiency monitor notice 37 displays a resource insufficiency notice message or the like on the output device 206. This operation is similar to FIG. 21.

<Replacement Operation 6>

FIG. 25 is a view showing a sixth job replacement operation when an immediate job is entered.

In FIG. 25, the number of execution on-going jobs using license LIC0 is 10, the number of execution on-going jobs using license LIC1 is five, and there are no vacant licenses in LIC0 or LIC1. If a new job H2JOB10 is entered in this state, it is not possible to execute the same.

Therefore, the resource release allocation job control 34 releases resources of license LIC0 and license LIC1. Actually, the operation is similar to FIG. 23(3).

<Replacement Operation 7>

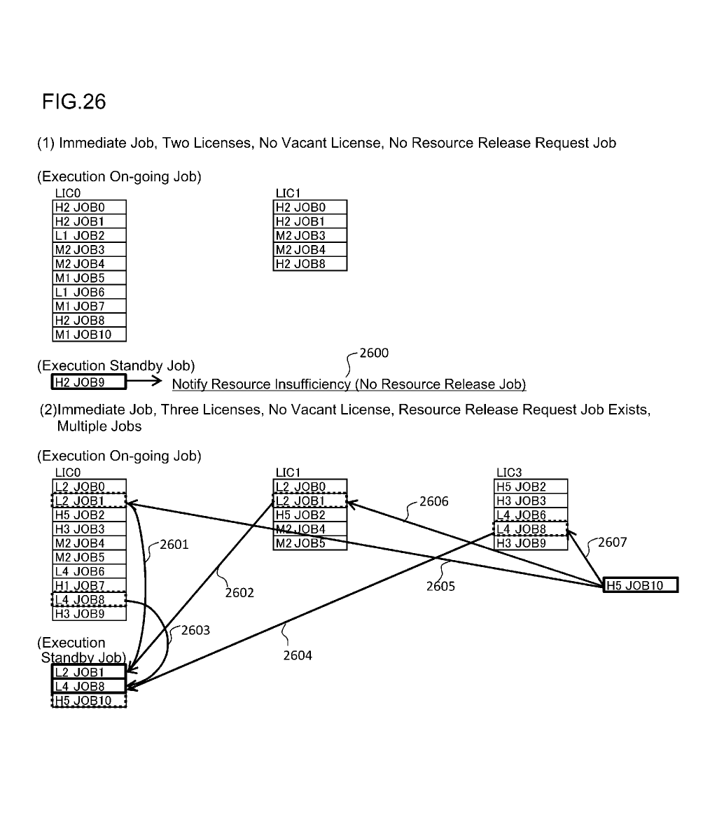

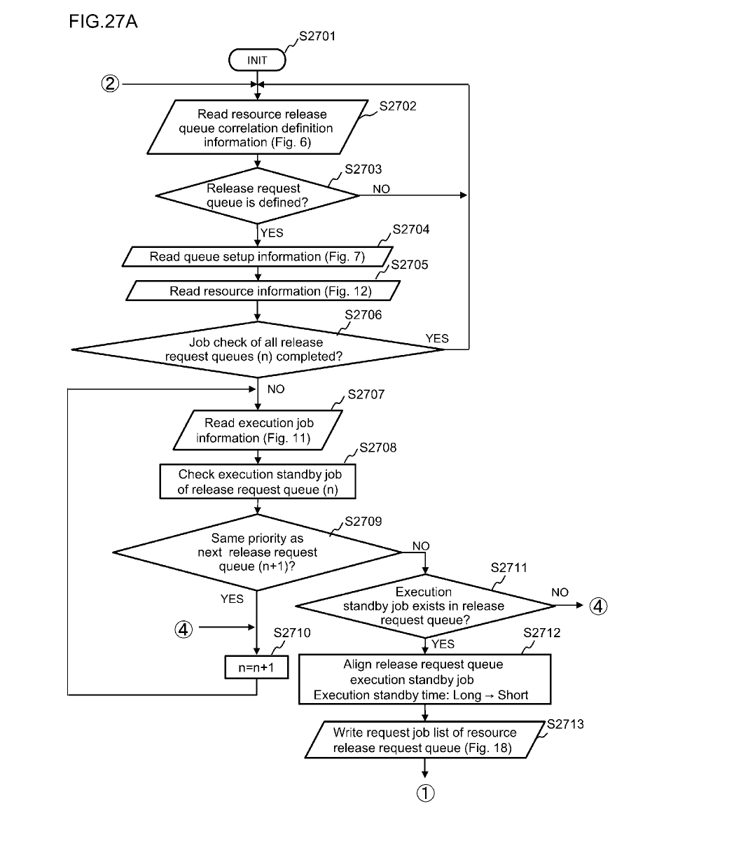

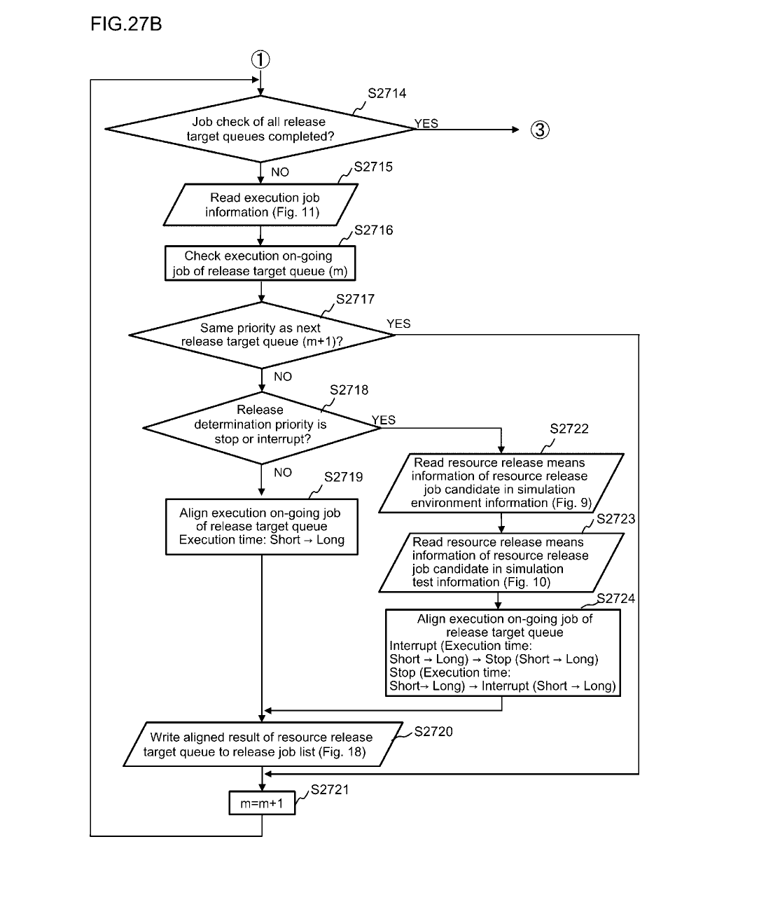

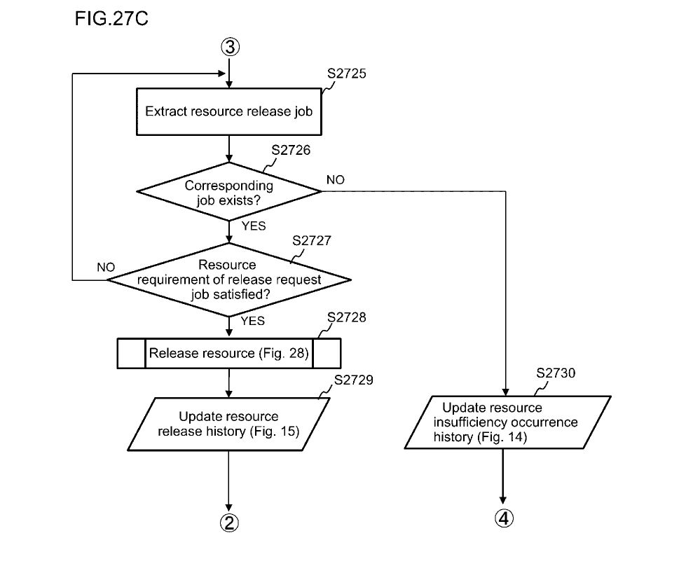

FIG. 26 illustrates a drawing showing the seventh job replacement operation when an immediate job is entered.

In FIG. 26(1), the number of execution on-going jobs using license LIC0 is ten, the number of execution on-going jobs using license LIC1 is five, and there are no vacant licenses in LIC0 or LIC1. Further, regarding the release request queue H2 of the newly entered job H2JOB9, a releasable release target queue is not defined in the resource release queue correlation definition information 60.

In this state, it is not possible to release the resource of the execution on-going job and to replace jobs. Therefore, the resource release allocation job control 34 notifies this state to the resource insufficiency monitor notice 37, which displays a resource insufficiency notice message or the like on the output device 206. This operation is similar to FIGS. 21 and 24. Further, even if the release target queue with respect to the release request queue H2 of job H2JOB9 is defined in the resource release queue correlation definition information 60, if there is no execution on-going job, a similar process is performed.

FIG. 26(2) shows the replacement of jobs when a job H5JOB10 requiring three licenses (LIC0, LIC1, LIC3) is newly entered.

In FIG. 26(2), the number of execution on-going jobs using license LIC0 is ten, the number of execution on-going jobs using license LIC1 and the number of execution on-going jobs using license LIC3 are five each, and there are no vacant licenses in the three licenses. Therefore, the resource release allocation job control unit 34 releases resources of licenses LIC0, LIC1 and LIC3.

At first, the resource release allocation job control unit 34 sets queue L5 having the highest release queue priority “10” as the release target queue candidate based on the content “L5=10, L4=5, L2=5” of release target queue 602 in which the release request queue 601 is “H5” in the resource release queue correlation definition information 60. However, since the job of the L5 queue is not executed, it is not possible to release the resource.

Therefore, the resource release allocation job control unit 34 sets the queues L4 and L2 in which the release queue priority is “5” is set as the release target queue candidate. There are two jobs of queue L4, L4JOB6 and L4JOB8, so that the resource release allocation job control unit 34 extracts a job capable of releasing the resource in the execution time based on the content “execution time” of the release determination priority 603 of the resource release queue correlation definition information 60. Then, the resource release allocation job control unit 34 selects a job having the shortest execution time out of the extracted jobs, that is, job L4JOB8.

The resource release allocation job control unit 34 either interrupts or stops the job L4JOB8, and stores the same in the execution standby job queue as shown in reference numbers 2603 and 2604. Thereby, the resource release allocation job control unit 34 is capable of releasing resources which are license LIC0 and license LIC3.

Next, the resource release allocation job control unit 34 releases the resource of license LIC1. Since there is no queue using only license LIC1, the resource release allocation job control unit 34 selects a job of queue L2 executed using license LIC1.

Since the corresponding jobs are L2JOB0 and L2JOB1, the resource release allocation job control unit 34 interrupts L2JOB1 having a short execution time, moves the same to the execution standby job queue as shown in reference numbers 2601 and 2602, and releases the resource of license LIC1. However, since the resource of license LIC0 is released at the same time, one extra license LIC0 is released.

By releasing resources of jobs L4JOB8 and L2JOB1, the licenses LIC0, LIC1 and LIC3 can be used by job H5JOB10, so that it can be entered to the execution on-going job queue as shown in reference numbers 2605 through 2607.

Since the priorities of the jobs L2JOB1 and L4JOB8 having the resources released are the same “P1”, so that the resource release allocation job control unit 34 determines the order of the execution standby job so that the job having the longest execution time is resumed with priority. In other words, the resource release allocation job control unit 34 stores the jobs L2JOB1 and L4JOB8 in the named order to the execution standby job queue.

As described, the resource release allocation job control unit 34 can release the resource of one or more jobs of a queue having a low emergency level and allocate the same to a job having a high emergency level using the resource release queue correlation definition information 60. Therefore, the job of a queue having a high emergency level can be executed immediately, and the efficiency of use of resource can be enhanced. Further, it becomes easy to recognize the resource insufficiency state, so that the resource management of the license can be improved.

<Resource Release and Allocation Job Control>

FIGS. 27A through 27C are flowcharts showing the operation of the resource release and allocation job control. In the following description, the subject of processing is either the resource release allocation job control unit 34 or the resource insufficiency monitor notification unit 37, but the subject can also be the CPU 201.

Further, a resource release processing of a release target job is performed with respect to a single release request job. That is, during creation of a single release target list, a release target job is released, but the release processing of a release target job with respect to a different release request job is not performed at the same time.

It is possible that the state of use of resources may be varied even during the job release processing, such as by having a newly entered normal job. Therefore, there are cases where the vacant license is being used and re-determination of a request resource of a subsequent job is required. Therefore, the resource release processing of a release target job is performed with respect to only a single release request job.

In S2701, the resource release allocation job control unit 34 starts the processing of a resource release allocation job control.

In S2702, the resource release allocation job control unit 34 reads the resource release queue correlation definition information 60 (FIG. 6) from the queue management database 391.

In S2703, the resource release allocation job control unit 34 determines whether a release request queue has been defined or not in the resource release queue correlation definition information 60. If the release request queue is defined (S2703: Yes), the resource release allocation job control unit 34 executes process S2704. If the release request queue is not defined (S2703: No), the resource release allocation job control unit 34 re-executes step S2702.

In S2704, the resource release allocation job control unit 34 reads the queue setup information 70 (FIG. 7) from the queue management database 391.

In S2705, the resource release allocation job control unit 34 reads the resource information 120 (FIG. 12) from the resource database 395.

In S2706, the resource release allocation job control unit 34 determines whether the check of jobs of all release request queues (n) has been completed or not. If the check has been completed (S2706: Yes), the resource release allocation job control unit 34 re-executes process S2702. If the check has not been completed (S2706: No), the resource release allocation job control unit 34 executes step S2707.

In S2707, the resource release allocation job control unit 34 reads the execution job information 110 (FIG. 11) from the job database 392.

In S2708, the resource release allocation job control unit 34 checks the execution standby jobs in the release request queue (n). In other words, the resource release allocation job control unit 34 confirms the content of priority 702 of the queue setup information 70.

In S2709, the resource release allocation job control unit 34 determines whether the priority of the subsequent release request queue (n+1) and the priority of the release request queue (n) are the same or not. If the priorities are the same (S2709: Yes), the resource release allocation job control unit 34 executes step S2710. If the priorities are not the same (S2709: No), the resource release allocation job control unit 34 executes process S2711.

In S2710, the resource release allocation job control unit 34 adds 1 to n, and the processes of S2707 and thereafter are executed again.

In the processes of S2707 to S2710 mentioned above, the resource release allocation job control unit 34 (job management system 2) can specify the queue of an execution standby job having the highest priority.

In S2711, the resource release allocation job control unit 34 determines whether there is an execution standby job that has a release request queue. If there is no execution standby job (S2711: No), the resource release allocation job control unit 34 performs the processing of the subsequent release request queue (n+1) starting from S2706. If there is an execution standby job (S2711: Yes), the resource release allocation job control unit 34 executes S2712.

In S2712, the resource release allocation job control unit 34 aligns the execution standby jobs of the resource release request queue in order from those having a longer execution standby time to those having a shorter standby time.

In S2713, the resource release allocation job control unit 34 writes the job information of the aligned resource release request queue to a resource release request queue request job list 160.

In S2714, the resource release allocation job control unit 34 determines whether all the jobs of the release target queue had been checked or not. If the check is completed (S2714: Yes), the resource release allocation job control unit 34 executes S2725. If the check has not been completed (S2714: No), the resource release allocation job control unit 34 executes S2715.

In S2715, the resource release allocation job control unit 34 reads the execution job information 110.

In S2716, the resource release allocation job control unit 34 checks the execution on-going job of the release target queue (m). Then, the resource release allocation job control unit 34 creates or updates the release target queue list 170.

In S2717, the resource release allocation job control unit 34 compares the priority of the subsequent release target queue (m+1) with the release queue priority of the release target queue (m) using the resource release queue correlation definition information 60, and determines whether they are the same or not. If the release queue priorities are the same (S2717: Yes), the resource release allocation job control unit 34 executes S2721. If the priorities are not the same (S2717: No), the resource release allocation job control unit 34 executes S2718.

In S2718, the resource release allocation job control unit 34 determines whether “stop” or “interrupt” is set or not in the release determination priority 603 of the resource release queue correlation definition information 60. If it is set (S2718: Yes), the resource release allocation job control unit 34 executes S2722. If it is not set (S2718: No), the resource release allocation job control unit 34 executes S2719.

In S2719, the resource release allocation job control unit 34 aligns the execution on-going jobs of the resource release target queue in order from those having shorter execution times to those having longer execution times.

In S2720, the resource release allocation job control unit 34 writes the job information of the aligned resource release target queue to the resource release target job list 180 (FIG. 18).

In S2721, the resource release allocation job control unit 34 adds 1 to m, and repeats the processes of S2714 and thereafter.

In S2722, the resource release allocation job control unit 34 reads a resource release means information 903 of the resource release job candidate in the simulation environment information 90.

In S2723, the resource release allocation job control unit 34 reads a resource release means information 1004 of the resource release job candidate in the simulation test information 100.

In S2724, the resource release allocation job control unit 34 aligns the execution on-going jobs of the release target queue. When the resource release means is set in the order of “interruption/resumption” and “stop/re-execution” in the resource release means information 903 or the resource release means information 1004, the resource release allocation job control unit 34 first aligns the jobs set to “interruption/resumption” in order from the jobs having shorter execution times to jobs having longer execution times. Since the simulation information to the interruption point must be saved, the storage resource can be used efficiently if the job having the shorter execution time is stopped.

Next, the resource release allocation job control unit 34 aligns the jobs set to “stop/re-execution” in order from the jobs having shorter execution times to jobs having longer execution times. In the case of stop/re-execution, simulation must be re-executed from the beginning, so that the jobs having shorter execution times should be stopped to use licenses and resources such as memories efficiently.

If the resource release means is set in the order of “stop/re-execution” and “interruption/resumption” in the resource release means information 903 or the resource release means information 1004, the resource release allocation job control unit 34 first aligns the jobs set to “stop/re-execution” in order from the jobs having shorter execution times to jobs having longer execution times.

Next, the resource release allocation job control unit 34 aligns the jobs set to “interruption/resumption” in order from the jobs having shorter execution times to jobs having longer execution times. In S2720, the resource release allocation job control unit 34 writes the job information of the aligned resource release target queue to the resource release target job list 180.

In the processes from S2714 to S2724, the resource release allocation job control unit 34 (job management system 2) is capable of extracting candidates of jobs for releasing resources.

In S2725, the resource release allocation job control unit 34 extracts a job from the resource release target queue having the resource requested by the resource release request queue.

In S2726, the resource release allocation job control unit 34 determines whether there exists a resource release target job (corresponding job). If there is no corresponding job (S2726: No), the resource release allocation job control unit 34 executes S2730. If there exists a corresponding job (S2726: Yes), the resource release allocation job control unit 34 executes S2727.

In S2727, the resource release allocation job control unit 34 determines whether the resource release target job satisfies the resource conditions of the resource release request job. If there exists a satisfying resource release target job (S2727: Yes), the resource release allocation job control unit 34 executes the resource release processing of S2728. If there exists no satisfying resource release target job (S2727: No), the resource release allocation job control unit 34 re-executes S2725.

It has been described with reference to FIG. 26(2) that there are multiple licenses, which are licenses LIC0, LIC1 and LIC3, required to execute a single job H5JOB10 of the release request queue. It is possible to satisfy the necessary licenses required for executing a single release request queue job by a single release target job, but there are cases where it is necessary to satisfy the licenses via two or more release target jobs. Therefore, in the processes of S2725 to S2727, the resource release allocation job control unit 34 determines whether there exists a job capable of satisfying the resources or not.

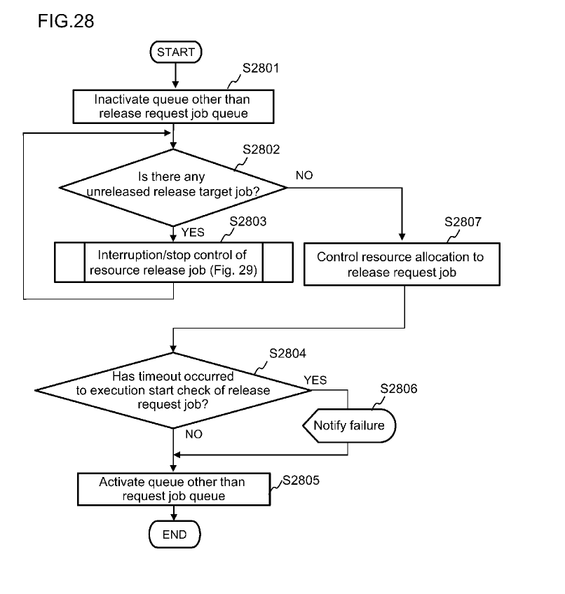

In S2728, the resource release allocation job control unit 34 executes a resource release processing (FIG. 28) with respect to the resource release target job.

In S2729, the resource release allocation job control unit 34 updates the resource release history 150 (FIG. 15), returns the process to S2702, and re-executes the subsequent processes.

In S2730, the resource release allocation job control unit 34 updates the resource insufficiency occurrence history 140 (FIG. 14), and executes the processing of the subsequent release request queue (n+1) starting from S2707.

<Releasing and Allocating of Resource>

FIG. 28 is a flowchart illustrating a resource release—allocation processing. The resource release—allocation processing is executed by S2728 of FIG. 27C.

In S2801, the resource release allocation job control unit 34 inactivates the queues other than the release request job queue, and prevents the resources from being used by jobs of other queues.

In S2802, the resource release allocation job control unit 34 determines whether all release target jobs extracted from S2725 to S2727 have been released or not. If there is a releasable job (S2802: Yes), the resource release allocation job control unit 34 executes S2803. If there is no releasable job (S2802: No), that is, if a release resource can be acquired, the resource release allocation job control unit 34 executes S2807. In S2807, the resource release allocation job control unit 34 executes allocation of the released resource to the release request job. After allocation is completed, the resource release allocation job control unit 34 executes the job of the release request queue. Thereafter, the resource release allocation job control unit 34 executes S2804.

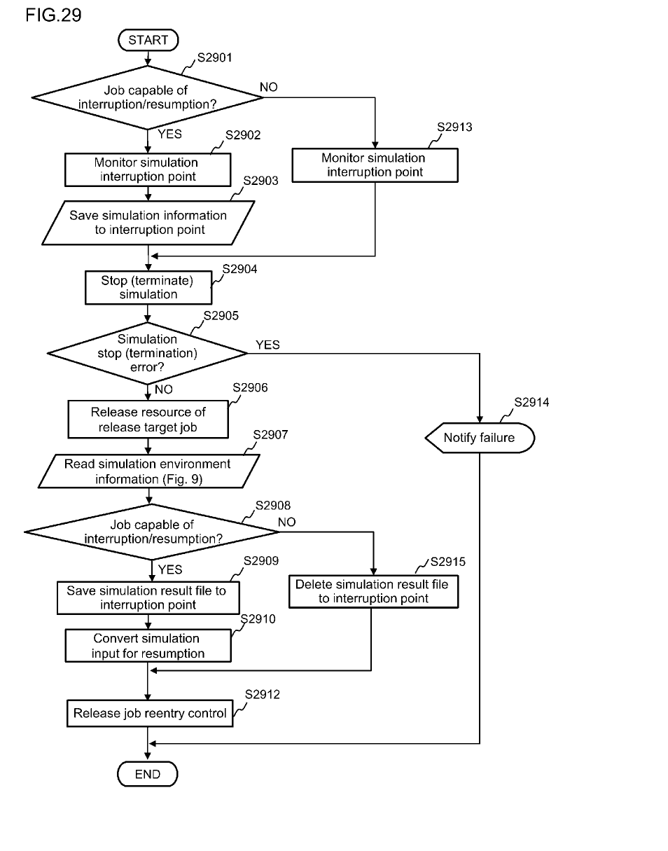

In S2803, the resource release allocation job control unit 34 performs interruption/stop control of the resource release job of FIG. 29. When the process of interruption/stop control of the resource release job is completed, the resource release allocation job control unit 34 re-executes S2802.

In S2804, the resource release allocation job control unit 34 checks the status of the release request job to which the resource is allocated, and determines whether timeout has occurred. If timeout has occurred (S2804: Yes), the resource release allocation job control unit 34 executes S2806. If timeout has not occurred (S2804: No), the resource release allocation job control unit 34 executes S2805.

In S2805, the resource release allocation job control unit 34 activates the queue having been inactivated in S2801.

In S2806, the resource release allocation job control unit 34 sends a failure notice. Actually, the resource release allocation job control unit 34 either displays a failure information on the output device 206 or sends a mail message to the user terminal 23 so as to notify the status to the system administrator or the user.

After executing the process of S2805, the resource release allocation job control unit 34 moves on to S2729, and updates the resource release history 150.

<Job Interruption/Stop Control>

FIG. 29 is a view showing a flowchart of the process for controlling the interruption/stop of a resource release job.

In S2901, the resource release allocation job control unit 34 determines whether the resource release target job is a job that can be interrupted/resumed based on the resource release means 903 of the simulation environment information 90 or the resource release means 1004 of the simulation test information 100.

If the job can be interrupted/resumed (S2901: Yes), the resource release allocation job control unit 34 executes S2902. If the job cannot be interrupted/resumed (S2901: No), the resource release allocation job control unit 34 executes S2913.

In S2902, the resource release allocation job control unit 34 specifies a simulation interruption point where the simulation can be ended correctly and the simulation can be continued correctly until execution is resumed, and monitors whether the simulation has been executed to that interruption point. The content of the process of S2913 is to specify the simulation interruption point where simulation can be terminated correctly.

In S2903, the resource release allocation job control unit 34 saves the execution information of simulation to the interruption point where simulation can be correctly resumed to the release job data save area 394 or the save area of the simulation data area 393.

In S2904, the resource release allocation job control unit 34 stops (terminates) the simulation.

In S2905, the resource release allocation job control unit 34 determines whether error has occurred by stopping (terminating) the simulation. If error has occurred (S2905: Yes), the resource release allocation job control unit 34 executes the failure notice of S2914. If error has not occurred (S2905: No), the resource release allocation job control unit 34 executes S2906.

In S2906, the resource release allocation job control unit 34 executes the releasing of resources of the release target job. This operation is the same as the operation described with reference to FIG. 20A and the like.

In S2907, the resource release allocation job control unit 34 reads the log/option etc. of the simulation environment information 90.

In S2908, the resource release allocation job control unit 34 determines whether the job having interrupted the simulation is a job capable of being interrupted/resumed based on the resource release means 903 of the simulation environment information 90 or the resource release means 1004 of the simulation test information 100.

If the job is capable of being interrupted/resumed (S2908: Yes), the resource release allocation job control unit 34 executes S2909. If the job is not capable of being interrupted/resumed (S2908: No), the resource release allocation job control unit 34 executes S2915. The resource release allocation job control unit 34 deletes the unnecessary simulation result file to the interruption point in S2915 since re-execution is performed without resuming S2915. Further, after deleting the simulation result file, the resource release allocation job control unit 34 releases the work area in the memory 202 or the storage unit 21 (data 39) used for job execution.

In S2909, the resource release allocation job control unit 34 saves the simulation result file to the interruption point to the release job data save area 394 or the save area of the simulation data area 393. After saving the simulation result file, the resource release allocation job control unit 34 releases the work area in the memory 202 or the storage unit 21 (data 39) used for job execution.

In S2910, the resource release allocation job control unit 34 performs change of simulation parameters in the resumed simulation and the simulation execution scenario (input stimulus of a test program).

In S2912, the resource release allocation job control unit 34 controls the re-entry of the job having released the resources.

Actually, the job having released the resources is arranged in the execution standby job queue. At this time, the resource release allocation job control unit 34 performs control so that the job having released the resources is executed with priority.

As described, the resource release allocation job control unit 34 enables the resources of a queue having a low emergency level to be released and allocated to the job of a queue having a high emergency level. Therefore, the jobs of a queue having a high emergency level can be executed immediately, and the efficiency of use of resources can be improved.

<Notice of Resource Insufficiency>

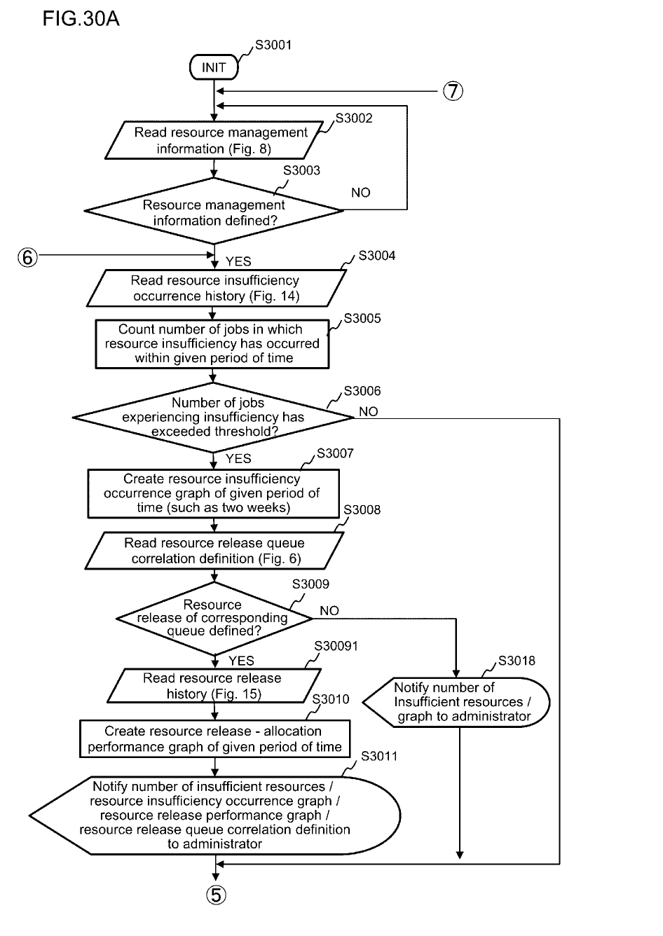

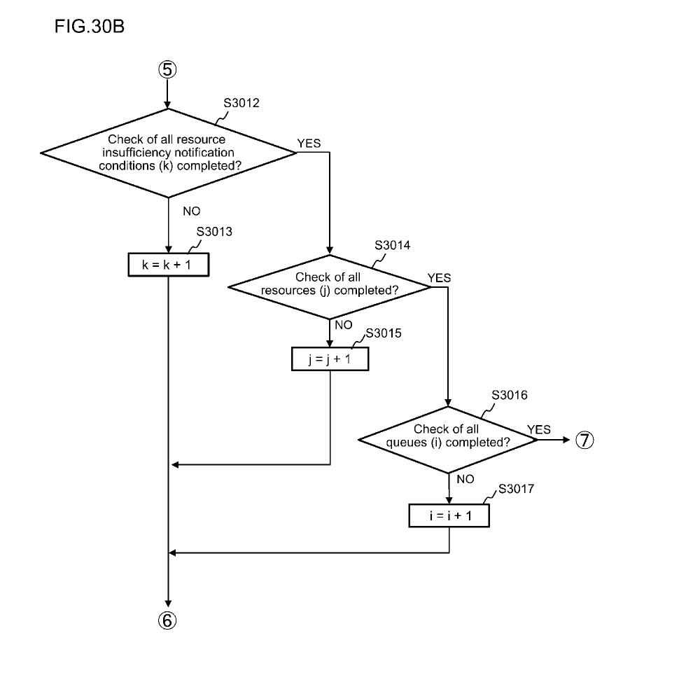

FIGS. 30A and 30B are flowcharts showing the process for controlling a resource insufficiency monitor notice.

In S3001, the resource insufficiency monitor notification unit 37 starts the resource insufficiency monitor notice processing.

In S3002, the resource insufficiency monitor notification unit 37 reads the resource management information 80 stored in the queue management database 391.

In S3003, the resource insufficiency monitor notification unit 37 determines whether a given content is defined in the resource management information 80. If it is not defined (S3003: No), the resource insufficiency monitor notification unit 37 re-executes S3002. If it is defined (S3003: Yes), the resource insufficiency monitor notification unit 37 executes S3004.

In S3004, the resource insufficiency monitor notification unit 37 reads a resource insufficiency occurrence history 140 from the resource database 395.

In S3005, the resource insufficiency monitor notification unit 37 counts the number of jobs in which resource (j) is insufficient within the given period of time of queue (i).

In S3006, the resource insufficiency monitor notification unit 37 determines whether the number of counted jobs in which resource insufficiency has occurred has exceeded a threshold of resource insufficiency notice condition (k) or not. If the number of jobs has not exceeded the threshold (S3006: No), the resource insufficiency monitor notification unit 37 executes S3012. If the number of jobs has exceeded the threshold (S3006: Yes), the resource insufficiency monitor notification unit 37 executes S3007.

In S3007, the resource insufficiency monitor notification unit 37 creates an occurrence graph of resource insufficiency of a given period of time (such as for the past two weeks).

In S3008, the resource insufficiency monitor notification unit 37 reads a resource release queue correlation definition 60 from the queue management database 391.

In S3009, the resource insufficiency monitor notification unit 37 determines whether there exists a resource release definition of the corresponding queue (i). If there is no resource release definition (S3009: No), the resource insufficiency monitor notification unit 37 executes S3018. If there is a resource release definition (S3009: Yes), the resource insufficiency monitor notification unit 37 executes S30091. In S3018, the resource insufficiency monitor notification unit 37 notifies the number of insufficient resources in the corresponding queue (i) and the resource insufficiency occurrence graph to the administrator.

In S30091, the resource insufficiency monitor notification unit 37 reads the resource release history 150 (FIG. 15). Then, in S3010, the resource insufficiency monitor notification unit 37 creates a performance graph of the resource release/allocation within a predetermined period of time (for example, for the past two weeks).

In S3011, the resource insufficiency monitor notification unit 37 notifies to the system administrator the number of insufficient resources, the resource insufficiency graph, the resource release—allocation performance graph and the resource release queue correlation definition, and suggests re-examination of the settings or the like.

In S3012, the resource insufficiency monitor notification unit 37 determines whether the check of all the resource insufficiency notice conditions (k) has been completed or not. If the check has been completed (S3012: Yes), the resource insufficiency monitor notification unit 37 executes S3014. If the check has not been completed (S3012: No), the resource insufficiency monitor notification unit 37 executes S3013.

In S3013, the resource insufficiency monitor notification unit 37 adds 1 to k, and in the subsequent resource insufficiency notice conditions (k), the check of the resource insufficiency occurrence history of S3004 and subsequent steps is executed.

In S3014, the resource insufficiency monitor notification unit 37 determines whether the check of all resources (j) has been completed or not. If the check has been completed (S3014: Yes), the resource insufficiency monitor notification unit 37 executes S3016. If the check has not been completed (S3014: No), the resource insufficiency monitor notification unit 37 executes S3015.

In S3015, the resource insufficiency monitor notification unit 37 adds 1 to j, and in the subsequent resource (j), the check of the resource insufficiency occurrence history of S3004 and thereafter is executed.

In S3016, the resource insufficiency monitor notification unit 37 determines whether the check of all the queues (i) have been completed or not. If the check has been completed (S3016: Yes), the resource insufficiency monitor notification unit 37 re-executes the processes of S3002 and thereafter. If the check has not been completed (S3016: No), the resource insufficiency monitor notification unit 37 executes S3017.

In S3017, the resource insufficiency monitor notification unit 37 adds 1 to i, and in the subsequent queue (i), the check of the resource insufficiency occurrence history of S3004 and thereafter is executed.

According to the above-described process, the resource insufficiency monitor notification unit 37 (job management system 2) can monitor resource insufficiency and the notice of the insufficient resource information to the system administrator. Therefore, the system administrator is capable of coping with license resource insufficiencies speedily, according to which the resource use efficiency can be improved, or the waiting time of simulation or the suspended time can be cut down.

<Management Screen>

FIG. 31 is a view showing a configuration example of a management screen. The management screen displays (1) a notification message, and a (2) occurrence graph/performance graph. Management screen refers to an output device 206 of a job management system 2 or a display screen (not shown) of a user terminal 23.

(1) Notification Message

The resource insufficiency monitor notification unit 37 can display on the management screen a message such as the one denoted by reference number 3101, which is “2012/4/20 17:00 Resource release request definition of queue H1 is not defined. Setup is suggested”. Thereby, the job management system 2 can prevent the occurrence of an undefined resource release request.

Similarly, the resource insufficiency monitor notification unit 37 can also display together with the setup information a message such as the one denoted by reference number 3102, which is “2012/4/21 10:00 Resource release request definition of queue H1 is as follows. Re-examination of setup is suggested”. Thereby, the job management system 2 can suggest the re-examination of resource release request to the system administrator.

Further, the resource insufficiency monitor notification unit 37 can display a resource insufficiency notification message such as the one denoted by reference number 3103, which is “2012/5/15 16:00 Insufficiency of license LIC0 of queue H1 is 31 times/hour, which has exceeded the resource insufficiency condition (20 times/hour), reaching 155%”. Thereby, the job management system 2 can provide quantitative data, such as the type of the license experiencing resource insufficiency, the number of times resource insufficiency has occurred, and the ratio of the number of times resource insufficiency has occurred to the threshold, to the system administrator.

The resource insufficiency monitor notification unit 37 can display a notification message of resource release—allocation insufficiency such as the one denoted by reference number 3104 saying “2012/5/15 16:01 Queue L0 is released and released resource LIC0 is allocated to queue H1”. Thereby, the job management system 2 can provide the status of release and status of allocation of resources to the system administrator.

(2) Occurrence Graph/Performance Graph

Further, the resource insufficiency monitor notification unit 37 can display, in addition to the above messages, a “resource insufficiency occurrence graph” (2-1) having assembled the number of jobs in which resource insufficiency has occurred in time-series.

In addition, the resource insufficiency monitor notification unit 37 can display on the management screen the “resource release—allocation performance graph” (2-2) showing the performance of the number of jobs of the queues being released in response to the resource insufficiency for each license of the release request queue. This resource release—allocation performance graph shows in a graph which release queue has released the license being allocated and used. A given value can be entered as the threshold (20) displayed in the graph through the management screen and the input device 205.

As described, the present embodiment enables to use the resources of licenses efficiently by suggesting to set up the definition of a resource release request in an undefined queue or by suggesting re-examination of setting. Further, the insufficient state of resources can be recognized speedily by notifying resource insufficiency.

Furthermore, through visualization using graphs of the resource insufficiency or the resource release allocation performance, it encourages recognition of a long-term or chronic resource insufficiency, according to which the efficiency of use of resources can be improved by reinforcing resources.

As described, in order to execute the job having a high emergency level immediately, the resource of a job of a release target queue having a low emergency level is release with respect to an execution standby job of the queue requesting release of resource, and allocates the released resource to the aforementioned job. Thereby, the present invention enables to overcome the prior art problem of not being able to enter a new job until the already entered job being executed is ended when the usable license type of usable number of licenses become insufficient. Furthermore, since there is no need to keep a vacant license for jobs having a high emergency level according to the present invention, the efficiency of use of licenses can be improved.

According to the above description, the execution resource for executing jobs was the software license operated in the execution computer 22, but the present invention can also be applied to physical execution resources such as the hardware resources of the execution computer 22 shown in FIG. 3, such as the MP of the computer unit 2201, the shared memory 2202, the cache memory 2207 and the disk 2211 of the storage unit 221.

The present invention is not restricted to the embodiments mentioned above, and other various modified examples are included in the scope of the invention. The preferred embodiments of the present invention have been merely illustrated for better understanding of the present invention, and not necessarily all the components illustrated herein are required to realize the present invention. A portion of the configuration of an embodiment can be replaced with the configuration of another embodiment, or the configuration of an embodiment can be added to the configuration of another embodiment. Moreover, all portions of the configurations of the respective embodiments can have other configurations added thereto, deleted therefrom, or replaced therewith.

Moreover, a portion or all of the configurations, functions, processing units, processing means and the like described in the description can be realized by hardware such as by designed integrated circuits. The respective configurations, functions and the like can also be realized by software such as by having a processor interpret the program for realizing the respective functions and through execution of the same.

The information such as the programs, tables, files and the like for realizing the respective functions can be stored in storage devices such as memories, hard disks and SSDs (Solid State Drives), or in storage media such as IC cards, SD cards and DVDs.

The control lines and information lines considered necessary for description are illustrated, and not all the control lines and information lines required for production are illustrated. Actually, it can be considered that almost all components are mutually connected.

### REFERENCE SIGNS LIST

2 Job management system

11 Execution on-going job queue

12 Execution standby job queue

13 Execution on-going job

14 Execution standby job

22 Execution computer

23 User terminal

34 Resource release allocation job control unit

37 Resource insufficiency monitor notice unit

60 Resource release queue correlation definition information

70 Queue setup information

1. A job management system coupled to an execution computer and a user terminal, the job management system comprising:
a control unit for performing control of a job to be executed via the execution computer; and
a storage unit for storing an execution information of the job;
wherein the control unit is caused to set up an execution resource information for executing the job and an emergency level information of execution for each job, and store the set up execution resource information and the emergency level information in the storage unit;
when there is insufficiency in the execution resource for executing a job to be executed via the execution computer, release one or more execution resources of one or more jobs in which execution is on-going having a lower emergency level than said job; and
allocate the released execution resource to said job to be executed and have said job executed via the execution computer.

2. The job management system according to claim 1, wherein the execution resource is a software license for a logical simulator to be executed in the execution computer.

3. The job management system according to claim 1, wherein the execution resource information includes:
a release request queue information storing a job requesting release of an execution resource;
a release target queue information composed of a release target queue type with respect to the release request queue and a release priority order information of each release target queue type; and
a release determination priority for determining a priority of a means for releasing the release target queue;
wherein the control unit is caused to extract a job candidate stored in a queue for releasing the execution resource based on the release request queue information and the release target queue information; and
determine the job for releasing the execution resource from the extracted job candidate based on the release determination priority.

4. The job management system according to claim 3, wherein the release determination priority is composed of one or more of the following: (1) interruption and resumption of a job, (2) stopping and re-execution of a job, and (3) job execution time.

5. The job management system according to claim 4, wherein the control unit is caused to:
select a job having a highest emergency level out of execution standby jobs stored in the release request queue;
when there exist a plurality of jobs after the above-described selection is performed, a job having a longest execution standby time is set as the job for requesting release of execution resource; and
release an execution resource from a job having a shortest execution time out of jobs in which execution is on-going in the release target queue having the highest release queue priority with respect to a release request queue having a highest emergency level based on the settings of the release determination priority.

6. The job management system according to claim 5, wherein the control unit allocates the released execution resource to a job having a highest emergency level out of the execution standby jobs stored in the release request queue.

7. The job management system according to claim 5, wherein if the releasing of execution resource is performed by interruption and resumption of a job, the control unit is caused to:
set up an interruption point where resumption of job execution can be performed correctly;
store a job execution information to the interruption point to the storage unit;
release an execution resource, and allocate the released execution resource to a job in the release request queue for job execution; and
prioritize the resumption of execution of the job having released the execution resource over other jobs having the same priority.

8. The job management system according to claim 5, wherein if the releasing of execution of resource is performed by stopping and re-executing a job, the control unit is caused to:
set up an interruption point where the job can be stopped correctly;
delete a job execution information to the interruption point from the storage unit;
release an execution resource, and allocate the released execution resource to a job in the release request queue for job execution; and
prioritize the re-execution of the job having released the execution resource over other jobs having the same priority.

9. The job management system according to claim 5, wherein the control unit is caused to summarize the number of jobs where insufficiency of execution resource has occurred within a given period of time, and if the number exceeds a threshold set in advance, execute a resource insufficiency notice to the job management system or a user terminal, and if the released resource is allocated to an execution standby job of the release request queue, execute a resource allocation notice.

10. The job management system according to claim 5, wherein the control unit is caused to send a failure notice when error occurs in the stoppage or interruption of the job for releasing the execution resource or in the re-execution or resumption of the job.

11. The job management system according to claim 1, wherein the execution computer has as the execution resource a plurality of microprocessors, a plurality of memories and a plurality of storage devices.

12. A job control method comprising:
setting up an execution resource information for job execution and an emergency level information of execution for each job;
releasing an execution resource of a job by ending the job in which execution is on-going having a lower emergency level than a job when there is insufficiency in the execution resource for executing the job to be executed via the execution computer; and
allocating the released execution resource to the job and causing the job to be executed via the execution computer.

13. The job control method according to claim 12, wherein the execution resource is a software license for a logical simulator to be executed in the execution computer.

14. The job control method according to claim 12, wherein the execution computer has as the execution resource a plurality of microprocessors, a plurality of memories and a plurality of storage devices.
